(19) United States
(12) Patent Application Publication
(10) Pub. No.: US 2010/0111395 A1
(43) Pub. Date: May 6, 2010

(54) X-RAY IMAGE ANALYZING SYSTEM AND PROGRAM

(75) Inventor: Yasuaki Tamakoshi, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 12/595,268

(22) PCT Filed: Apr. 8, 2008
(86) PCT No.: PCT/JP2008/056918

§ 371 Date: Oct. 9, 2009

(30) Foreign Application Priority Data
Apr. 12, 2007 (JP) 2007105222

(51) Int. Cl. G06K 9/00; G01N 23/06

(52) U.S. Cl. 382/132; 378/54

(57) ABSTRACT

An X-ray image analyzing system, including:

an X-ray source for radiating an X-ray; an X-ray detector for detecting an X-ray image radiated onto an x-ray image detection surface, wherein phase contrast X-ray simple imaging is capable of being performed determining a trabecular bone index computing region, computing a trabecular bone index indicating a state of a trabecula from image data in the trabecular bone index computing region, determining a bone-flesh boundary index computing region by a second region determination method different from the first region determination method, and computing a bone-flesh boundary index indicating smoothness of a bone-flesh boundary from image data in the bone-flesh boundary index computing region.

### TECHNICAL FIELD

The present invention relates to an X-ray image analyzing system and a program.

### BACKGROUND ART

It is said that the symptoms of arthropathy advance from the swelling of a joint, the inflammation of a synovial membrane, the breakages of a cartilage and a ligament in the neighborhood of the joint, and a minute breakage of a bone in the neighborhood of the joint (the formation of minute osteophytes and bone erosion, the decrease of trabeculae in the neighborhood of the joint, or the like) to a sightable breakage of a bone in the neighborhood of the joint in a simple X-ray image, the minimization of a joint fissure, and the luxation and the ankylosis of the joint. Accordingly, if indices indicating the degrees of the breakages of a cartilage and a ligament in the neighborhood of a joint and a minute breakage of a bone in the neighborhood of the joint can be obtained at the stage of the aforesaid incipient breakages, then it is conceivable that the indices are useful for an early diagnosis.

Moreover, a bone includes a part having a minute structure to be called as a cortical bone and a part having a cancellous anastomosis to be called as a cancellous bone, and an osteoporosis is a symptom of a decrease of the quantity of the spongin of a bone and the gradual decrease of virgate trabeculae constituting the anastomosis to weaken the bone. Accordingly, if the indices can be obtained from an image in which each trabecula is delineated in place of the indices obtained from the density of the whole cancellous bone, then it is conceivable that the indices are useful for an early diagnosis.

In recent years, it has been developed to acquire the aforesaid indices on the basis of an X-ray image. As the imaging system of the X-ray image, simple X-ray imaging, tomography, and the like have been known. As the tomography, for example, as described in Patent Document 1, there is the tomography using a minute focus X-ray tomogram imaging apparatus generating and radiating an X-ray of a minute focus from the focus size of 20 μm or less, which enables the obtainment of the spatial resolution of about 10 μm sufficient for the observation of a trabecula, preferably the focus size of 10 μm or less, and the Patent Document 1 describes that an X-ray image capable of ascertaining a trabecula structure can be thereby acquired.

However, the minute focus X-ray tomogram imaging apparatus is expensive, and the radiation intensities of the X-rays of a minute focus X-ray source are low. Consequently, the imaging time for obtaining a tomogram becomes long, and a patient, who is a subject, is obliged to be restrained for a long time. Thus the minute focus X-ray tomogram imaging apparatus has the drawback of the large burden of a patient.

On the other hand, because the simple X-ray imaging restrains a subject for a shorter time in comparison with that of the tomography, X-ray images enabling the sighting of trabecula structures are desired to be acquired by the simple X-ray imaging. For example, Patent Document 2 describes that it is possible to compute osseous part structure state index values from simple X-ray imaging by image processing.

Patent Document 1: Japanese Patent Application Laid-Open Publication No. Hei 9-294740
Patent Document 2: Japanese Patent Application Laid-Open Publication No. Hei 11-112877

### DISCLOSURE OF INVENTION

### Problems to Be Solved by the Invention

However, the simple X-ray imaging has the advantages that the apparatus is inexpensive, and that an imaging time necessary for obtaining one X-ray image is short, in comparison with those of the tomography. But, the conventional simple X-ray imaging with no modifications can delineate large osteophytes, large bone erosion, and remarkable decreases of trabeculae, but cannot draw minute osteophytes, minute bone erosion, and minute decreases of trabeculae. Consequently, the X-ray images obtained by the conventional simple X-ray imaging have been impossible to enable the acquirement of the indices indicating the useful states of trabeculae and the indices indicating bone-flesh boundaries.

Accordingly, it is an object of the present invention to realize the computations of both of a trabecular bone index indicating the states of a trabecula and a bone-flesh boundary index indicating the smoothness of a bone-flesh boundary from an X-ray image obtained by simple X-ray imaging, which needs a small-sized apparatus and a short imaging time necessary for obtaining an X-ray image in comparison with tomography. Thereby, it can be expected that the early diagnoses of arthropathy and osteoporosis become enable.

### Means for Solving the Problems

An X-ray image analyzing system according to the invention of claim 1 includes:
an X-ray source for radiating an X-ray;
an X-ray detector for detecting an X-ray image radiated onto an X-ray image detection surface, wherein

phase contrast X-ray simple imaging is capable of being performed under conditions that the X-ray source radiates an X-ray having an X-ray average energy of 32 KeV or less and a diameter of an focused X-ray beam of 150 μm or less, a distance from a subject to the X-ray image detection surface is 0.2 m or more, a ratio M of a distance from the X-ray source to the X-ray image detection surface to a distance from the X-ray source to the subject is 1.5 or more, and a detection interval between pixels on the X-ray image detection surface is 100×M (μm) or less; and

an image analyzer for, from the X-ray image obtained by the phase contrast X-ray simple imaging based on a first region determination method, determining a trabecular bone index computing region, computing a trabecular bone index indicating a state of a trabecula from image data in the trabecular bone index computing region, determining a bone-flesh boundary index computing region by a second region determination method different from the first region determination method, and computing a bone-flesh boundary index indicating smoothness of a bone-flesh boundary from image data in the bone-flesh boundary index computing region.

The invention of claim 2 is the X-ray image analyzing system according to claim 1, wherein the image analyzer acquires an X-ray intensity profile to positions from the image data in the trabecular bone index computing region, and analyzes the X-ray intensity profile to compute the trabecular bone index.

The invention of claim 3 is the X-ray image analyzing system according to claim 2, wherein the image analyzer acquires the X-ray intensity profile to the positions in each direction of two or more intersecting directions from the image data in the trabecular bone index computing region, and analyzes the X-ray intensity profile to compute the trabecular bone index.

The invention of claim 4 is the X-ray image analyzing system according to claim 3, wherein the image analyzer performs the analysis in each of the two or more intersecting directions and compares each analysis result to compute the trabecular bone index.

The invention of claim 5 is the X-ray image analyzing system according to any one of claims 2-4, wherein the image analyzer obtains a trabecular image number pertaining to the number of trabecular images within a predetermined range at a time of analyzing the X-ray intensity profile.

The invention of claim 6 is the X-ray image analyzing system according to any one of claims 2-5, wherein the image analyzer obtains a trabecular image interval pertaining to an interval of the trabecular images within the predetermined range at the time of analyzing the X-ray intensity profile.

The invention of claim 7 is the X-ray image analyzing system according to any one of claims 2-6, wherein the image analyzer uses frequency analysis at the time of analyzing the X-ray intensity profile.

The invention of claim 8 is the X-ray image analyzing system according to any one of claims 1-7, wherein

the bone-flesh boundary index computing region includes a bone portion in a neighborhood of a bone-flesh boundary in the subject, and

the image analyzer analyzes the X-ray intensity profile at a position of the bone portion in the neighborhood of the bone-flesh boundary to compute the bone-flesh boundary index.

The invention of claim 9 is the X-ray image analyzing system according to any one of claims 1-8, wherein

the bone-flesh boundary index computing region includes the bone-flesh boundary in the subject to an extent of able to analyze a shape, and

the image analyzer acquires bone-flesh boundary shape data indicating the shape of the bone-flesh boundary from the image data in the bone-flesh boundary index computing region, and analyzes the bone-flesh boundary shape data to compute the bone-flesh boundary index.

The invention of claim 10 is the X-ray image analyzing system according to claim 9, wherein the image analyzer uses the frequency analysis at a time of analyzing the bone-flesh boundary shape data.

The invention of claim 11 is the X-ray image analyzing system according to any one of claims 1-10, wherein

the bone-flesh boundary index computing region includes the bone portion in the neighborhood of the bone-flesh boundary in the subject, and

the image analyzer computes the bone-flesh boundary index based on information corresponding to maximum X-ray intensity of the image data in the bone-flesh boundary index computing region.

The invention of claim 12 is the X-ray image analyzing system according to any one of claims 1-11, wherein the X-ray imaging apparatus is arranged between the X-ray source and the X-ray detector, the X-ray imaging apparatus including a subject stand supporting the subject so that the ratio M of the distance from the X-ray source to the X-ray image detection surface to the distance from the X-ray source to the subject is 1.5 or more.

The invention of claim 13 is the X-ray image analyzing system according to claim 12, wherein the subject stand supports a hand.

The invention of claim 14 is the X-ray image analyzing system according to any one of claims 1-12, wherein the X-ray image is that of the subject of the hand or a foot.

A program according to claim 15 is A program to be performed by a computer for performing operation processing from operation source image data output from an X-ray detector of an X-ray imaging system comprising an X-ray imaging apparatus including an X-ray source and the X-ray detector, comprising the steps of:

determining a trabecular bone index computing region from an X-ray image obtained by phase contrast X-ray simple imaging based on a first region determination method;

computing a trabecular bone index indicating a state of a trabecula from image data in the trabecular bone index computing region;

determining a bone-flesh boundary index computing region by a second region determination method different from the first region determination method; and

computing a bone-flesh boundary index indicating smoothness of a bone-flesh boundary from image data in the bone-flesh boundary index computing region, wherein

the X-ray imaging apparatus to enable the phase contrast X-ray simple imaging, including:
an X-ray source for radiating an X-ray; and
the X-ray detector for detecting an X-ray image radiated onto the X-ray image detection surface, wherein

the phase contrast X-ray simple imaging is performed under conditions that the X-ray source radiates an X-ray having an X-ray average energy of 32 KeV or more and a diameter of an focused X-ray beam of 150 μm or less, a distance from a subject to the X-ray image detection surface is 0.2 m or more, a ratio M of a distance from the X-ray source to the X-ray image detection surface to a distance of the X-ray source to the subject is 1.5 or more, and a detection interval between pixels on the X-ray image detection surface is 100×M (μm) or less.

The invention of claim 16 is the program according to claim 15, wherein the program makes the computer acquire an X-ray intensity profile to positions from the image data in the trabecular bone index computing region, and analyze the X-ray intensity profile to compute the trabecular bone index.

The invention of claim 17 is the program according to claim 16, wherein the program makes the computer acquire the X-ray intensity profile to the positions of two or more intersecting directions from the image data in the trabecular bone index computing region, and analyze the X-ray intensity profile to compute the trabecular bone index.

The invention of claim 18 is the program according to claim 17, wherein the program makes the computer perform analysis in the two or more intersecting directions, and compare each analysis result to each other to compute the trabecular bone index.

The invention of claim 19 is the program according to any one of claims 16-18, wherein the program makes the computer obtain a trabecular image number at a time of analyzing the X-ray intensity profile.

The invention of claim 20 is the program according to any one of claims 16-19, wherein the program makes the computer obtain the trabecular image interval at the time of analyzing the X-ray intensity profile.

The invention of claim 21 is the program according to any one of claims 16-20, wherein the program makes the computer use frequency analysis at the time of analyzing the X-ray intensity profile.

The invention of claim 22 is the program according to any one of claims 15-21, wherein

the bone-flesh boundary index computing region includes a bone portion in a neighborhood of the bone-flesh boundary in the subject, and

the program makes the computer analyze the X-ray intensity profile to the positions of the bone portion in the neighborhood of the bone-flesh boundary to compute the bone-flesh boundary index.

The invention of claim 23 is the program according to any one of claims 15-22, wherein

the bone-flesh boundary index computing region includes the bone-flesh boundary in the subject to a degree of being capable of analyzing a shape, and

the program makes the computer acquire bone-flesh boundary shape data indicating the shape of the bone-flesh boundary from the image data in the bone-flesh boundary index computing region, and analyze the bone-flesh boundary shape data to compute the bone-flesh boundary index.

The invention of claim 24 is the program according to claim 23, wherein the program makes the computer use the frequency analysis at a time of analyzing the bone-flesh boundary shape data.

The invention of claim 25 is the program according to any one of claims 15-24, wherein

the bone-flesh boundary index computing region includes the bone portion in the neighborhood of the bone-flesh boundary in the subject, and

the program makes the computer compute the bone-flesh boundary index based on information corresponding to a maximum X-ray intensity of the image data in the bone-flesh boundary index computing region.

Incidentally, the aforesaid phase contrast X-ray simple imaging indicates the X-ray simple imaging having a phase contrast effect useful for the image analysis of the present invention, and the phase contrast X-ray simple imaging is performed under conditions that the X-ray source radiates an X-ray having an X-ray average energy of 32 KeV or less and a diameter of an focused X-ray beam of 150 μm or less, a distance from a subject to the X-ray image detection surface is 0.2 m or more, a ratio M of a distance from the X-ray source to the X-ray image detection surface to a distance of the X-ray source to the subject is 1.5 or more, and a detection interval between pixels on the X-ray image detection surface is 100×M (μm) or less.

The inventor of the present invention made the present invention by the discovery of the capability of computing both of an appropriate trabecular bone index and a bone-flesh boundary index by performing the image analysis of the image of a minute structure of a subject, which image can be obtained with a good contrast, which is produced by the synergistic effect of the following enabled effects by this phase contrast X-ray simple imaging enabling a phase effect by X-ray refraction in a subject, an expansion imaging effect including little blurring, and a low energy X-ray imaging effect.

The above-stated diameter of the focused X-ray beam (μm) can be measured by the method defined in (2.2) Slit Camera in 7.4.1 Focus Examination of Japanese Industrial Standards (JIS) Z 4704-1994. Incidentally, it is a matter of course that further highly accurate measurement becomes possible by selecting the conditions that make accuracy highest from the point of view of the measuring principle according to the character of an X-ray source among the optional selection conditions in the measuring method.

The above-stated detection interval between pixels indicates a pixel pitch of the image to be detected. When the ratio of the distance from a subject to an X-ray image detection surface to the distance from an X-ray source to the subject is denoted by M, the detection interval between pixels in the present invention is 100×M (μm) or less. Then, the detection interval between pixels is preferably 70×M (μm) or less. Moreover, it is better that the detection interval between pixels is 10 μm or more, and the detection interval between pixels is further preferable to be 30 μm or more (especially 60 μm or more) from the point of view of X-ray quantum noises.

Moreover, the detection interval between pixels corresponds to the pixel pitch of a two-dimensional image sensor in the case where an X-ray detector 11 is the two-dimensional image sensor, and corresponds to the reading pixel pitch of a reading apparatus to read an image accumulated in a photostimulable phosphor plate in the case of the photostimulable phosphor plate.

Moreover, the above-stated distance from the subject to the X-ray image detection surface is the distance from a position of the subject nearest to the X-ray image detection surface to the X-ray image detection surface within an irradiation range of the X-ray image detection surface to be detected. Incidentally, although the X-ray image detection surface has a thickness, the X-ray image detection surface is very thin, and the thickness is smaller than the distance by one digit or more to be within an error range 1.

Moreover, the above-stated distance from the X-ray source to the subject is the distance from the focus of the X-ray source to the position nearest to the X-ray image detection surface of the subject in the direction perpendicular to the X-ray image detection surface within the irradiation range of an X-ray detected on the X-ray image detection surface. Incidentally, strictly speaking, the focus of the X-ray source strictly has a thickness, but the thickness is smaller than the distance by one digit or more to be within an error range.

Moreover, the above-stated trabecular bone index section an index indicating the state of a trabecula. Incidentally, a healthy bone has dense trabeculae and high X-ray absorption factors, but if a person develops a bone disease, then the trabeculae become coarse owing to an osteoporosis, a bone cyst, or the like, and also the absorption of an X-ray inclines to be lower.

Moreover, the above-stated bone-flesh boundary index is an index indicating the smoothness of a bone-flesh boundary. Incidentally, a healthy bone has a smooth bone-flesh boundary (the surface of a bone), but if a person develops a bone disease, then the bone-flesh boundary inclines not to be smooth owing to bone erosion, an osteophyte, a bone cyst, or the like.

The above-stated X-ray intensity profile to positions is the information indicating the quantities corresponding to X-ray intensities irradiated onto an X-ray image detection surface at positions. The X-ray intensity profile is preferably the information indicating the quantities corresponding to the X-ray intensities irradiated onto the X-ray image detection surface at the positions in a predetermined direction. Then, it is preferable to use an X-ray intensity profile to the positions in each direction of a plurality of intersecting directions.

The above-stated trabecular image number information is the information pertaining to the number of the trabecular images within a predetermined range. As the trabecular image number information like this, for example, the number of the trabecular images within a range in which the X-ray intensity profile to positions are obtained, the number of the trabecular images per a unit length within a specific range in the range in which the X-ray intensity profile to positions are obtained, and an average of the numbers of the trabecular images in a plurality of specific ranges can be given, but the trabecular image number information is not limited to them.

The above-stated trabecular image interval information is the information pertaining to the intervals of the trabecular image within a predetermined range. As the trabecular image interval information like this, for example, an interval obtained by dividing the length of a range in which the X-ray intensity profile to positions by the number of the trabecular images within the range, an interval obtained by dividing the length of a specific range in which the X-ray intensity profile to positions is obtained by the number of the trabecular images, and an average of the lengths of respective non-trabecular images when the range in which the X-ray intensity profile to positions is obtained is sectioned into a trabecular image region showing trabecular images and the non-trabecular image region showing the inclusion of no trabecular images can be given, but the trabecular image interval information is not limited to them.

The information corresponding to the maximum X-ray intensity of the image data in the above-stated bone-flesh boundary index computing region is the information pertaining to the maximum X-ray intensity of the image data in the bone-flesh boundary index computing region. As the information corresponding to the maximum X-ray intensity of the image data in the bone-flesh boundary index computing region like this, the image data value corresponding to the maximum X-ray intensity or a relative X-ray irradiating intensity among the image data in a bone-flesh boundary index computing region, a value obtained by normalizing the image data value corresponding to the maximum X-ray intensity or the relative X-ray irradiating intensity among the image data within the bone-flesh boundary index computing region by the image data values or the relative X-ray irradiating intensities in the regions except, for example, skipping areas and bone-flesh boundary index computing regions, the number of pixels of the image data corresponding to the intensities near to the maximum X-ray intensity from a predetermined point of view among the image data within the bone-flesh boundary index computing region, and the like can be given, but the information is not limited to them.

### EFFECTS OF THE INVENTION

According to the inventions of claims 1 and 15, it is possible to compute an appropriate trabecular bone index and a bone-flesh boundary index from a same X-ray image of a subject of a hand, and the early diagnoses of an arthropathy and an osteoporosis becomes possible,

According to the inventions of claims 2 and 16, because an X-ray intensity profile to the positions in each direction of two or more intersecting directions is acquired from the image data in a trabecular bone index computing region and a trabecular bone index is computed on the basis of the X-ray intensity profile, trabecular bone indices including fewer individual differences can be computed. Although the reason why the trabecular bone indices including fewer individual differences can be obtained includes un-elucidated parts, it can be conjectured that the reason is because the differences of the numbers of the trabeculae owing to the directions depend on the degree of progress of the bone diseases more than individual differences although the numbers of trabeculae greatly depend on the individual differences.

Moreover, according to the inventions of claims 8 and 22, because an X-ray intensity profile to the positions of a bone portion in the neighborhood of a bone-flesh boundary in a subject is acquired from the image data in a bone-flesh boundary index computing region and a bone-flesh boundary index is computed from the X-ray intensity profile, the bone-flesh boundary index having a strong correlation with the progress of a disease can be obtained. The reason why the bone-flesh boundary index having a strong correlation with the progress of a disease can be obtained includes an un-elucidated part. The image that can well reproduce a bone portion in the neighborhood of a bone-flesh boundary can be obtained by a multiplier effect of a sufficient phase contrast effect as mentioned above, the clarification of a boundary having an X-ray refractive index difference, the capability of the delineation of the minute structure of a subject owing the an expansion imaging effect including little blurring, and the obtainability of a strong absorption contrast optimum for an X-ray imaging image of a hand as a subject by a low energy X-ray imaging effect. In a disease such as a bone erosion and an osteophyte, the occurrence of the unevenness of the external form of a bone in the neighborhood of a bone-flesh boundary can be conjectured to have a strong with the progress of the disease in such a way that the bone quantity of a bone portion in the neighborhood of a bone-flesh boundary falls and the gradient of an intensity profile of the X-rays to the positions of the image data of a bone in the neighborhood of the bone-flesh boundary bone falls.

### BRIEF DESCRIPTION OF DRAWINGS

FIG. 1 is a diagram showing the configuration of the principal part of an X-ray image analyzing system in the present embodiment;

FIG. 2 is a side view showing the configuration of the principal part of the X-ray image imaging apparatus in the present embodiment;

FIG. 3 is a schematic view showing the internal configuration of the X-ray image imaging apparatus in the present embodiment;

FIG. 4 is a perspective view of an X-ray detector equipped in the X-ray image imaging apparatus in the present embodiment;

FIG. 5 is a plan view when a subject places his or her left hand in a hand holding portion of the present embodiment with the back of the hand facing upward;

FIG. 6 is a block diagram showing the control configuration of the ray image imaging apparatus in the present embodiment;

FIG. 7 is an explanatory view of an outline of phase contrast imaging in the present embodiment;

FIG. 8 is an explanatory view of a phase contrast effect;

FIG. 9 is a block diagram showing the control configuration of an image processing apparatus in the present embodiment;

FIG. 10 is a view showing an example of a phase contrast image obtained by the X-ray image imaging apparatus in the present embodiment;

FIG. 11 is an explanatory view showing the length and breadth directions of a radial bone in a shape list stored in a storage unit of the image processing apparatus in the present embodiment;

FIG. 12 is an explanatory view showing a trabecular bone index computing region determined in the phase contrast image of FIG. 10;

FIG. 13 is an explanatory view showing a profile direction in a trabecular bone index computing region of FIG. 12;

FIG. 14 is a diagram showing an example of an X-ray intensity profile for one line in a longitudinal direction or a lateral direction in the trabecular bone index computing region of FIG. 12;

FIG. 15 is an explanatory view showing a standard at the time of measuring each value from the X-ray intensity profile of FIG. 14;

FIG. 16 is a view of comparing the aspect ratios of the representative values of the trabecular image numbers of 15 healthy subjects and 15 osteoporosis patients;

FIG. 17 is a view of comparing the aspect ratios of the representative values of widths of the trabecular images of 15 healthy subjects and 15 osteoporosis patients;

FIG. 18 is a view of comparing the aspect ratios of the representative values of the depths of the trabecular images of 15 healthy subjects and 15 osteoporosis patients;

FIG. 19 is a view of comparing the aspect ratios of the respective values of the distances between the trabecular images of 15 healthy subjects and 15 osteoporosis patients;

FIG. 20A is a view of comparatively showing a trabecular of a normal bone trabecula and a trabecula of an osteoporosis bone, and is a real trabecula view;

FIG. 20B is a view of comparatively showing a trabecula of a normal bone and a trabecula of an osteoporosis bone, and is a schematic view of the trabeculae;

FIG. 21 is an example of an X-ray intensity profile for a line in a longitudinal direction or a lateral direction in an interest region of FIG. 12, and is a diagram showing the X-ray intensity profile of a healthy subject;

FIG. 22 is an example of an X-ray intensity profile for a line in a longitudinal direction or a lateral direction in the interest region of FIG. 12, and is a diagram showing the X-ray intensity profile of a patient;

FIG. 23 is a diagram showing an analysis result in the case of performing a Fourier analysis to the X-ray intensity profile of the healthy subject of FIG. 21;

FIG. 24 is a diagram showing an analysis result in the case of performing a Fourier analysis to the X-ray intensity profile of the patient of FIG. 22;

FIG. 25 is a diagram of superimposing a background level on the analysis result of FIG. 23;

FIG. 26 is a diagram of superimposing a background level on the analysis result of FIG. 24;

FIG. 27 is a diagram of subtracting a background level from the analysis result shown in FIG. 25;

FIG. 28 is a diagram of subtracting a background level from the analysis result shown in FIG. 26;

FIG. 29 is a diagram showing an analysis result in the case of performing a wavelet analysis to the X-ray intensity profile of the healthy subject of FIG. 21;

FIG. 30 is a diagram showing an analysis result in the case of performing a wavelet analysis to the X-ray intensity profile of the patient of FIG. 22;

FIG. 31 is a diagram showing an example of an X-ray intensity profile for a line in an absorption contrast image of a healthy subject;

FIG. 32 is a diagram showing an example of an X-ray intensity profile for a line in an absorption contrast image of a patient;

FIG. 33 is a diagram showing an analysis result in the case of performing a Fourier analysis to the X-ray intensity profile of the healthy subject of FIG. 31;

FIG. 34 is a diagram showing an analysis result in the case of performing a Fourier analysis to the X-ray intensity profile of the patient of FIG. 32;

FIG. 35 is a diagram showing an analysis result in the case of performing a wavelet analysis to the X-ray intensity profile of the healthy subject of FIG. 30;

FIG. 36 is a diagram showing an analysis result in the case of performing a wavelet analysis to the X-ray intensity profile of the patient of FIG. 31;

FIG. 37A is a view showing a process example of a phase contract image obtained by the X-ray image imaging apparatus of the present embodiment, and is an explanatory view showing an example of the phase contrast image;

FIG. 37B is a view showing a process example of a phase contrast image obtained by the X-ray image imaging apparatus of the present embodiment, and is an explanatory view showing a process of shape recognizing processing;

FIG. 38 is an explanatory view showing a profile direction of an evaluation object bone in the present embodiment;

FIG. 39 is a view showing profile directions in a bone-flesh boundary index computing region in the present embodiment;

FIG. 40 is an explanatory view showing an example of an X-ray intensity profile in the bone-flesh boundary index computing region of FIG. 39;

FIG. 41A is an explanatory view showing the kinds of the angle index values in the present embodiment, and shows an example of setting an acute angle d2 and an obtuse angle d1 formed by a reference line a and a reference line c, or an acute angle d3 and an obtuse angle d4 formed by a reference line b and the reference line c as the angle index values;

FIG. 41B is an explanatory view showing the kinds of the angle index values in the present embodiment, and shows an example of setting an interval L1 between a boundary starting point p5 and a boundary ending point P6 as the angle index values;

FIG. 41C is an explanatory view showing the kinds of the angle index values in the present embodiment, and shows an example of setting a signal value width S and a profile length Y at the time of shifting from the boundary starting point P5 to the bone side by a stipulated distance X as the angle index values;

FIG. 41D is an explanatory view showing the kinds of the angle index values in the present embodiment, and shows another example of the starting point of the stipulated distance X;

FIG. 42A is an explanatory view of comparatively showing a bone state of a healthy subject and a bone state of a bone erosion patient in the present embodiment, and shows respective trabecula states of the healthy subject and the bone erosion patient;

FIG. 42B is an explanatory view of comparatively showing the bone state of the healthy subject and the bone state of a bone erosion patient in the present embodiment, and shows the states of the respective bone borders of the healthy subject and the bone erosion patient;

FIG. 43 is an explanatory view of comparing an X-ray intensity profile of a bone erosion patient and an X-ray intensity profile of a healthy subject in present embodiment;

FIG. 44 is an explanatory view of comparing the representative values of the angle index values of 15 healthy subjects and 15 bone erosion patients;

FIG. 45A is a view showing a process example of a phase contrast image obtained by the X-ray image imaging apparatus in the present embodiment, and is an explanatory view showing an example of the phase contrast image;

FIG. 45B is a view showing a process example of the phase contrast image obtained by the X-ray image imaging apparatus in the present embodiment, and is an explanatory view showing the process of shape recognizing processing;

FIG. 46A is a view showing a process example at the time of acquiring the shape profile of an evaluation object bone in the present embodiment, and is an explanatory view showing a profile acquiring process;

FIG. 46B is a view showing a process example at the time of acquiring the shape profile of the evaluation object bone in the present embodiment, and is a graph showing an example of the shape profile [symbol] ;

FIG. 47 is an explanatory view of comparing computed indices (integration values Hf) of 5 healthy subjects and 5 bone disease patients;

FIG. 48 is a graph showing an example of a result of acquiring the shape profile of a joint portion of each of a bone disease patient and a healthy subject to perform a Fourier transformation of the shape profile in the present embodiment;

FIG. 49 is a graph showing an example of an acquisition region of an index pertaining to a disease in a joint portion in the present embodiment;

FIG. 50A is a view showing a process example of a phase contrast image obtained by the X-ray image imaging apparatus of the present embodiment, and is an explanatory view showing an example of the phase contrast image;

FIG. 50B is a view showing a process example of a phase contrast image obtained by the X-ray image imaging apparatus of the present embodiment, and is an explanatory view showing a process of joint portion recognizing processing;

FIG. 51A is an explanatory view showing a determination example of an n interest region of a joint portion in the present embodiment, and shows the border of the joint portion recognized by the bone-flesh boundary index computing section;

FIG. 51B is an explanatory view showing a determination example of the interest region of the joint portion in the present embodiment, and shows an example of setting the whole body of the joint portion as the bone-flesh boundary index computing region;

FIG. 51C is an explanatory view showing a determination example of an interest region of the joint portion in the present embodiment, and shows an example of setting a part of the joint portion as the bone-flesh boundary index computing region;

FIG. 52 is an explanatory view of comparatively showing the indices of 5 healthy subjects and 5 bone erosion patients;

FIG. 53 is an explanatory view of comparatively showing other indices of 5 healthy subjects and 5 bone erosion patients;

FIG. 54 shows a histogram of the X-ray intensity of each pixel in an interest region of a joint portion in the present embodiment, and is a graph of comparatively showing the histograms of bone disease patients and healthy subjects;

FIG. 55 is an explanatory view of comparatively showing other indices of 5 healthy subjects and 5 bone erosion patients;

FIG. 56 is an explanatory view of comparatively showing other indices of 5 healthy subjects and 5 bone erosion patients;

FIG. 57 is a flow chart showing a piece of processing to be executed in the X-ray image imaging apparatus in an X-ray image processing method according to the present embodiment;

FIG. 58 is a flow chart showing a piece of processing to be executed by the image processing apparatus in the X-ray image processing method according to the present embodiment;

FIG. 59 is a flow chart showing a piece of processing to be executed by the image output apparatus in the X-ray image processing method according to the present embodiment; and

FIG. 60 is an explanatory view showing X-ray intensity profiles of X-ray images of an X-ray image by ordinary imaging and a phase contrast image in the present embodiment.

### REFERENCE NUMERALS

1 X-ray image imaging apparatus
2 supporting stand
3 supporting base
4 imaging apparatus main body unit
5 supporting shaft
6 drive apparatus
7 holding member
8 X-ray source
9 power source unit
11 X-ray detector
12 X-ray detector holding unit
13 X-ray dose detecting unit
14 subject stand
22 control apparatus
24 operation apparatus
29 X-ray detector identifying unit
30 image processing apparatus
31 control unit
32 storage unit
33 input unit
34 communication unit
35 image processing unit
36 trabecular bone index computing unit
37 bone-flesh boundary index computing section
50 image output apparatus
100 X-ray image analyzing system
R trabecular bone index computing region

### BEST MODE FOR CARRYING OUT THE INVENTION

In the following, the best mode for implementing the present invention will be described with reference to the accompanying drawings.

Incidentally, the description of the present column shows the mode that the inventor recognizes to be best for implementing the present invention, and the description includes the expressions that seem to conclude or define the range of the invention and the terms used in claims apparently. But those expressions are those for specifying the mode that the inventor recognizes to be best to the last, and are not the ones that specify or limit the range of the invention and the terms used in the claims. Moreover, the range of the invention is not limited to the shown examples.

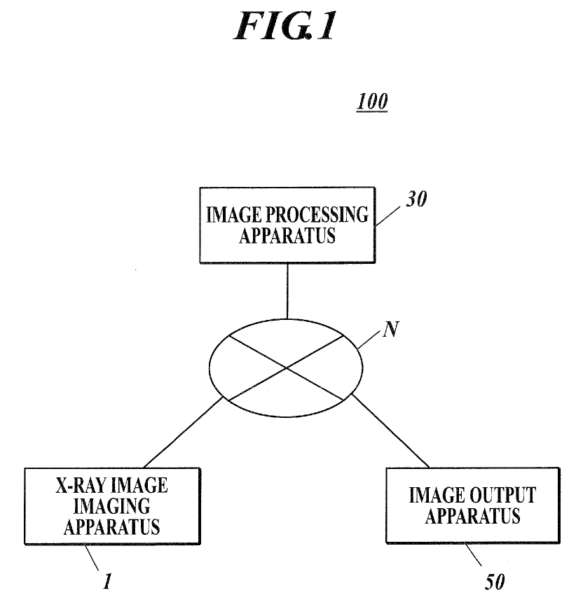

FIG. 1 shows a configuration example of an X-ray image analyzing system 100 in a present embodiment. In the present embodiment, the X-ray image analyzing system 100 is composed of an X-ray image imaging apparatus 1 to generate an image of an imaging object by radiating an X-ray to the imaging object, an image processing apparatus 30 to perform the image processing of an image generated by the X-ray image imaging apparatus 1 and the like, and an image output apparatus 50 to perform the display, the film output, or the like of the image and the like, which have been subjected to the image processing or the like by the image processing apparatus 30. Each apparatus is connected to a communication network (hereinafter simply referred to as “network”) N, such as a local area network (LAN), through, for example, a not-shown switching hub. The X-ray image imaging apparatus 1 and the image processing apparatus 30 are an image analyzer according to the present invention.

Incidentally, the configuration of the X-ray image analyzing system 100 is not limited to the exemplified one here, but, for example, the configuration may be the one in which the image processing apparatus 30 and the image output apparatus 50 are integrated to one body to perform image processing and outputting (displaying, film outputting, or the like) of the image subjected to the image processing by the integrated apparatus.

[X-Ray Imaging System]

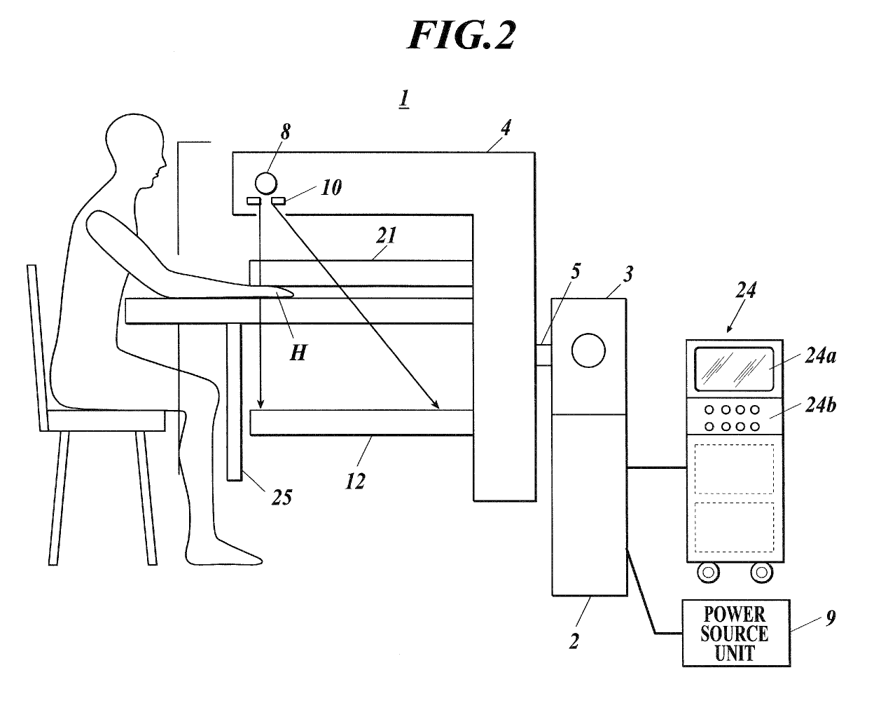

First, the X-ray image imaging apparatus 1 will be described with reference to FIGS. 2-8.

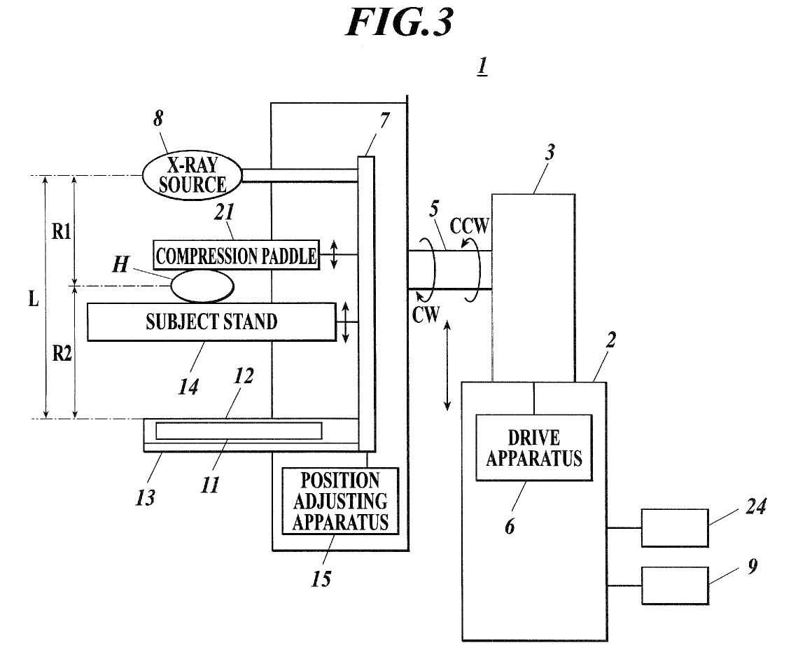

FIGS. 2 and 3 show a configuration example of the X-ray image imaging apparatus 1. The X-ray image imaging apparatus 1 is provided with a supporting base 3 in a freely ascendible and descendible state to a supporting stand 2. The supporting base 3 supports an imaging apparatus main body unit 4 rotatably in a clockwise (CW) direction and a counterclockwise (CCW) direction through a supporting shaft 5. The supporting base 3 is provided with a drive apparatus 6 to drive the ascent and the descent of the supporting base 3 and the rotation and the rotation of the supporting shaft 5. The drive apparatus 6 is provided with a not-shown publicly known drive motor or the like. The supporting base 3 and the imaging apparatus main body unit 4 are configured to ascend and descend according to the position of a subject H. It is made to be possible to adjust the position of the subject H at a position where the subject H can take a posture in which the subject H puts his or her arm on a subject stand 14 not to be easily tired.

The imaging apparatus main body unit 4 is provided with a holding member 7 along a vertical direction. An X-ray source 8 to radiate an X-ray to the subject H at a low tube voltage is attached to the upper part of the holding member 7. A power source unit 9 to apply a tube voltage and a tube current to the X-ray source 8 is connected to the X-ray source 8 through the supporting shaft 5, the supporting base 3, and the imaging apparatus main body unit 4. The X-ray radiation aperture of the X-ray source 8 is provided with a diaphragm 10 to adjust an X-ray irradiation field in the state of being freely openable and closable. Moreover, the diameter of the focused X-ray beam of the X-ray source 8 is made to be changeable according to an imaging system, which will be described later.

[X-Ray Source]

As the X-ray source 8, for example, a Coolidge X-ray tube, such as a rotation anode X-ray tube, which is widely used in a medical front and a nondestructive inspection facility, can be given. Incidentally, in the rotation anode X-ray tube, an X-ray is generated by a collision of an electron beam radiated from the cathode thereof to the anode thereof. The generated X-ray is incoherent like a natural light, and is not a parallel light X-ray but a diverging ray. If an electron beam continues to irradiate a fixed position of the anode, then heat is generated to injure the anode, and accordingly a generally used X-ray tube prevent the life of the anode from being shortened by rotating the anode. An X-ray generated by colliding an electron beam to a certain size of the surface of the anode is radiated from the certain size of a plane of the anode toward the subject H. The size of the plane viewed from the radiation direction (subject direction) is called as an actual focal spot (focus).

Incidentally, the X-ray source 8 is not limited to the X-ray tube, but may be a micro focus X-ray source described in, for example, Japanese Patent Application Laid-Open Publication No. Hei 9-171788, Japanese Patent Application Laid-Open Publication No. 2000-173517, and Japanese Patent Application Laid-Open Publication No. 2001-273860, a synchrotron radiation X-ray source described in, for example, Japanese Patent Application Laid-Open Publication No. Hei 5-217696 and Japanese Patent Application Laid-Open Publication No. 2002-221500, a plasma X-ray source described in, for example, Japanese Patent Application Laid-Open Publication No. Sho 47-24288, Japanese Patent Application Laid-Open Publication No. Sho 64-6349, Japanese Patent Application Laid-Open Publication No. Sho 63-304597, Japanese Patent Application Laid-Open Publication No. Sho 63-304596, Japanese Patent Application Laid-Open Publication No. Hei 1-109646, and Japanese Patent Application Laid-Open Publication No. Sho 58-158842, a laser X-ray source described in, for example, Japanese Patent Publication No. 3490770, and the like. But, the X-ray source 8 is not limited to the above ones.

It is preferable that the X-ray average energy of an X-ray is 13 KeV or more (especially 16 KeV or more) because, even if the subject H is a live animal or a ligament, an absorption exposure becomes little, and no long time radiation for 10 seconds or longer is necessary, and furthermore, also the blurring of the subject H in an imaging time is suppressed. Moreover, it is preferable that the X-ray average energy of an X-ray is 32 KeV or less (especially 25 KeV or less) because the refraction caused by a bone can be sufficiently detected and it becomes possible to effectively use an obtained image for a diagnosis and the like.

Incidentally, as an X-ray tube, for example, a Coolidge X-ray tube, which is widely used in medical fronts, and a rotation anode X-ray tube are preferably used. At that time, if molybdenum (Mo), which is used for mammography, is used as a target (anode) of an X-ray tube, then generally an X-ray of the X-ray average energy of 17-18 KeV is radiated at the determined value of the tube voltage of 32 kVp, and an X-ray of the X-ray average energy of 20 Kev is radiated at the determined value of the tube voltage of 39 kVp. Moreover, if tungsten (W), which is used for general imaging, is used as a target, then an X-ray of the X-ray average energy is 22 KeV is radiated at the determined value of the tube voltage of 30 kVp, and an X-ray of the X-ray average energy is 32 KeV is radiated at the determined value of 50 kVp.

Moreover, the diameter of the focused X-ray beam of the X-ray source 8 is preferably 20 μm or more (especially 30 μm or more) so as to be able to radiate the X-ray of the X-ray average energy within the above-mentioned range and to be able to obtain a practical output intensity. Moreover, the diameter of the focused X-ray beam of the X-ray source 8 is preferably 150 μm or less (especially 100 μm or less) so as to obtain a distinct image under the restriction of the size of the imaging apparatus.

[X-Ray Detector]

An X-ray dose detecting unit 13 to detect a radiated X-ray quantity with the X-ray detector 11 is provided on the under surface of an X-ray detector holding unit 12 in the lower part of the holding member 7.

The X-ray detector 11 is a photostimulable phosphor plate, a two-dimensional image sensor, or the like, for detecting the X-ray radiated from the X-ray source 8 to transmit the subject H on an X-ray image detection surface.

As the two-dimensional pixel sensor, for example, a flat panel detector (FPD) to acquire a signal based on the X-ray irradiation quantity of each of many two-dimensionally arranged pixels is preferable. As such an FPD, a direct type FPD including an array sensor to directly convert an X-ray into charges to detect the X-ray may be used, or an indirect type FPD including an scintillator to convert an X-ray into a light and an array sensor to convert the light converted by the scintillator into charges to detect the converted charges may be used. Then, as the indirect type FPD, one having a columnar crystal phosphor, one having an array sensor and a phosphor packed in a box formed every pixel, which is described in Japanese Patent Publication No. 3661196 and the like, one having an applied medium in which grains of a phosphor are dispersed, and the like can be given, but the indirect type FPD is not limited to the above ones.

Incidentally, the thicker the thickness of the scintillator is, the higher the sensitivity thereof becomes. The thinner the thickness of the scintillator is, the higher the spatial resolution thereof becomes. Moreover, the spectral sensitivity of a scintillator changes according to the kind of the scintillator. Moreover, as the phosphor of a scintillator, an alkali halide metal, such as CsI:Tl, or alkali halide earth metal is preferable.

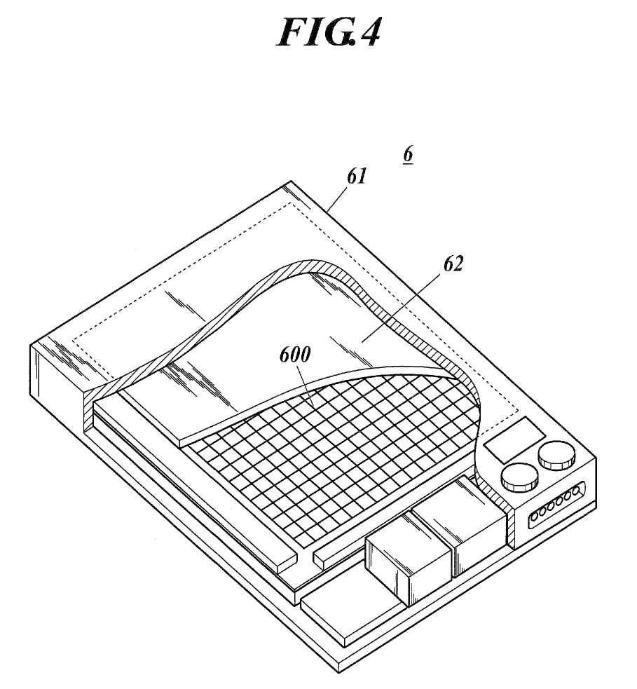

The structure of the X-ray detector 11 will be described using the FPD as an example with reference to FIG. 4. FIG. 4 is a perspective view of the X-ray detector 11. The X-ray detector 11 is provided with a housing 61 to protect the inside of the X-ray detector 11, and is configured to be portable as a cassette.

Imaging panels 62 to convert a radiated X-ray into an electric signal are formed in layers in the housing 61. A light emitting layer (not shown) to emit a light according to the intensity of an incident X-ray is provided on the side of the surface irradiated by the X-ray of each of the imaging panels 62.

The light emitting layer is generally called as a scintillator layer. The scintillator layer has, for example, a phosphor as the principal component, and outputs an electromagnetic wave (light) having a wavelength within a range from 300 nm to 800 nm, that is, over a range from an ultraviolet light to an infrared light around a visible light ray, on the basis of an incident X-ray.

On the surface of the light emitting layer which is opposite to the surface on the side of being irradiated by the X-ray, a signal detecting unit 600 is formed, which includes photoelectric conversion portions arranged in a matrix. Each of the photoelectric conversion portions converts an electromagnetic wave (light) output from the light emitting layer into electric energy to accumulate the converted electric energy therein, and outputs an image signal based on the accumulated electric energy. Incidentally, a signal output from a photoelectric conversion portion is a signal corresponding to a pixel, which is the minimum unit constituting X-ray image data. The signal detecting unit 600 extracts the accumulated electric energy as an electric signal by switching, and amplifies the extracted electric signal by a predetermined amplifying ratio (gain), and after that, the signal detecting unit 600 converts the amplified electric signal into digital data. In this way, X-ray image data is generated by the imaging panels 62.

The tabular subject stand 14 to hold the fingers of a subject, who is the subject H, from below is provided between the X-ray source 8 and the X-ray detector holding unit 12 with one end of the subject stand 14 attached to the holding member 7. The subject stand 14 is connected to a position adjusting apparatus 15 provided with a motor or the like to change the position of the subject stand 14 to the holding member 7 in order to adjust (positional adjustment in the height direction) the imaging magnification ratio at the time of phase contrast imaging.

The subject stand 14 is formed to project to the subject side more than the other end of the X-ray detector holding unit 12. A compression paddle 21 for pressing the subject H from the upper part thereof to fix the subject H is provided above the subject stand 14 with one end of the compression paddle 21 attached to the holding member 7. The compression paddle 21 can freely move along the holding member 7. The movement of the compression paddle 21 can be performed automatically or manually. The end face of the compression paddle 21 on the side of the subject H is arranged to project to the side of the subject H slightly more than the X-ray source 8 and the X-ray detector 11 (effective image end face), which are arranged in the substantially vertical direction. Consequently, if the imaging object range (for example right hand) of the subject H is arranged to be positioned on the side of the holding member 7 more than the compression paddle 21, then no image losses of a trabecular bone index computing region (imaging object range) are caused, and it is preferable. Moreover, it is preferable to form the end face of the subject stand 14 to be a curved surface shape so that an aged subject having an average habitus can rest his or her upper half of the body against the subject stand 14 in the sitting state on a chair X.

Moreover, in the present embodiment, a protector 25 is provided on the under surface of the subject stand 14 so as to extend into the substantially vertical direction in order that a person to be imaged can get into imaging position without hitting a leg against the X-ray detector holding unit 12. Hereby, the subject can get into the imaging position in the sitting state on the chair X without hitting a leg against the X-ray detector holding unit 12. Moreover, the protector 25 also makes it possible to prevent the useless exposure to radiation by the entering of a part of the body of the patient into an X-ray radiating region. Incidentally, the compression paddle 21 and the protector 25 are not indispensable constituent elements, but the configuration of not using the compression paddle 21 and the protector 25 may be adopted.

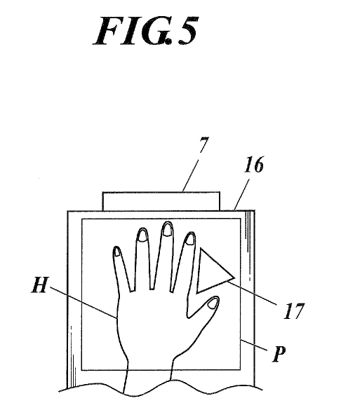

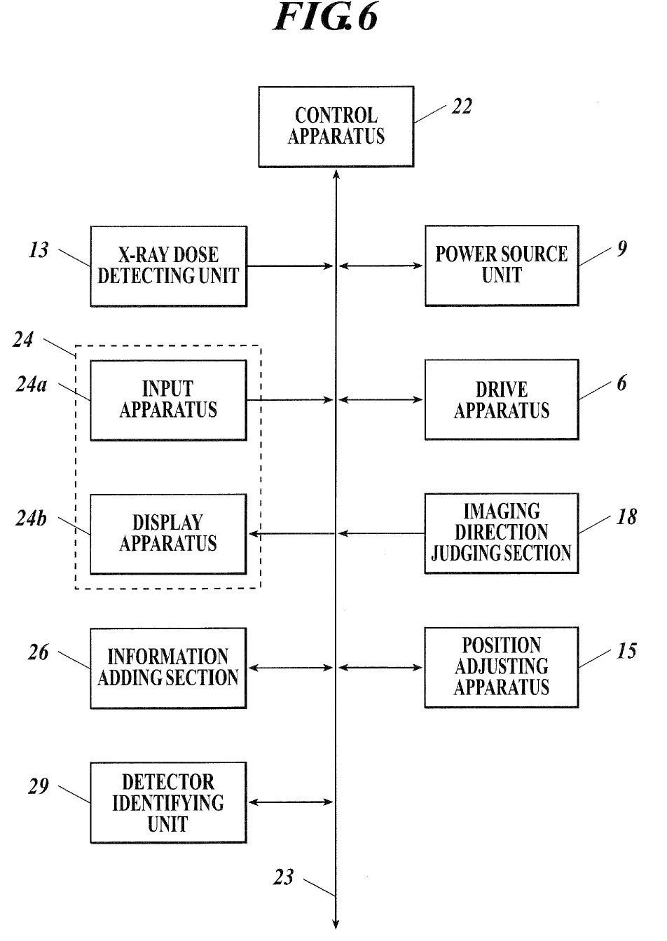

As shown in FIG. 5, the subject stand 14 is provided with a hand holding portion 16 to hold the fingers of a subject in the state of intersecting the X-ray radiating path. The size of the hand holding portion 16 is not especially limited as long as the fingers of the subject can be placed on the hand holding portion 16. A triangular magnet 17 arranged between a thumb and a forefinger to be touched by them in the state in which the subject places the fingers in the hand holding portion 16 is provided on the upper surface of the hand holding portion 16. Imaging direction judging section 18 (see FIG. 6) to detect a placed position of the triangular magnet 17 to judge the position of the thumb of the subject by using the detected position as imaging direction information is provided to the hand holding portion 16.

Here, an irradiation field Q at the time of imaging a bone joint of a hand has been previously determined so that two finger bones with the joint put between them may fall into the irradiation field Q (see FIG. 5). This is because, as it will be described later, an X-ray image is acquired by the phase contrast using a low tube voltage, which has a high sharpness at the time of bone joint imaging, and thereby analysis values endurable for following-up sufficiently can be obtained even from one place.

Incidentally, although the above description has been given by exemplifying the subject stand 14 of a hand, a trabecular bone index and a bone-flesh boundary index may be obtained from a foot by phase contrast X-ray simple imaging, which will be described later, and accordingly the subject stand may be one capable of easily place a foot thereon.

As shown in FIG. 6, the imaging apparatus main body unit 4 is provided with a control apparatus 22 composed of a central processing unit (CPU), a read only memory (ROM), and a random access memory (RAM). The control apparatus 22 is connected to the X-ray dose detecting unit 13, the power source unit 9, the drive apparatus 6, the position adjusting apparatus 15, information adding section 26, the imaging direction judging section 18, and an X-ray detector identifying unit 29 through a bus 23. Moreover, the control apparatus 22 is connected to an operation apparatus 24 including an input apparatus 24a and a display apparatus 24b, and the like. The input apparatus 24 includes a keyboard and a touch panel (not shown) for inputting an imaging condition, and the like, a position adjusting switch for adjusting the position of the subject stand 14, and the like. The display apparatus 24b includes a CRT display, a liquid crystal display, or the like. Incidentally, the imaging apparatus main body unit 4 may be provided with information acquiring section for acquiring patient information and the like by reading a bar code or the like besides.

The ROM of the control apparatus 22 stores a control program for controlling each section of the X-ray image imaging apparatus 1 and various processing programs. The CPU collectively controls the operation of each section of the X-ray image imaging apparatus 1 in cooperation with the control program and the various processing programs, performs phase contrast imaging, and functions as an image data generating section to generate the image data of a phase contrast image.

For example, the CPU controls the drive apparatus 6 to make the imaging apparatus main body unit 4 ascend and descend to a height according to the stature or the like of a subject on the basis of the judgment result by the imaging direction judging section 18, the imaging condition of the subject, and the like, and the CPU rotates the supporting shaft 5 in order to adjust an X-ray radiating angle. Then, the position adjusting apparatus 15 adjusts the position of the subject stand 14, and adjusts the enlargement factor of the phase contrast imaging. After that, the imaging apparatus main body unit 4 executes imaging processing, and applies a tube voltage to the X-ray source 8 with the power source unit 9 to radiate an X-ray to the subject H. Then, when the X-ray quantity input from the X-ray dose detecting unit 13 reaches a previously determined X-ray quantity, the imaging apparatus main body unit 4 stops the radiation of the X-ray from the X-ray source 8 with the power source unit 9. Moreover, the radiation condition of an X-ray may be determined in advance, and the radiation of an X-ray may be performed under the condition.

The imaging direction information acquired by the imaging direction judging section 18 and left and right information input from the input apparatus 24a are output to the information adding section 26 through the control apparatus 22 as described above. Moreover, the present embodiment is configured to receive the inputs of patient information (the information of a person to be imaged) pertaining to the subject H, the information of the date, the time, and the like of imaging (imaging time information), region information pertaining to the imaging region indicating which region of the patient the imaged subject H is, and the like from the operation apparatus 24, not-shown information acquiring section, and the like. The input information is output to the information adding section 26 through the control apparatus 22. Incidentally, if the control apparatus 22 is equipped with a timer function, then the X-ray image imaging apparatus may be configured so that, when imaging is performed, the control apparatus 22 automatically acquires an imaging time without inputting the imaging time information at another time, and that the control apparatus 22 outputs the imaging time to the information adding section 26 as the imaging time information to be added to the image data.

The information adding section 26 is configured to associate these various pieces of information (the imaging direction information, the left and right information, the information of a person to be imaged, the imaging time information, the region information, and the like), as the additional information, with the image data of the phase contrast image to be generated. Incidentally, the additional information to be added to image data by the information adding section 26 is not limited to the above-mentioned additional information. For example, the ID information of a patient (a person to be imaged) and the like may be added. Moreover, the information adding section 26 is not limited to the one exemplified here, which adds all pieces of information, but may be the one adding any piece of the information.

The X-ray detector identifying unit 29 is incorporated in the X-ray detector holding unit 12, and discriminates whether the X-ray detector 11 set in the X-ray detector holding unit 12 is for ordinary imaging, for phase contrast imaging, or highly expanding phase contrast imaging. To put it concretely, the X-ray detector identifying unit 29 performs the discrimination by reading a mark (concavo-convex portion) for discrimination provided to the housing of the X-ray detector 11 or the like, a conduction portion, an RFID, a bar code, or the like. Then, the X-ray detector identifying unit 29 compares the X-ray detector 11 with, for example, the imaging condition input from the operation apparatus 24 to judge whether the X-ray detector 11 is fitted to the X-ray imaging to be performed from now on or not, and the X-ray detector identifying unit 29 outputs the discrimination result to the control apparatus 22. If the discrimination result is incongruent, the control apparatus 22 controls the display apparatus 24b to make the display apparatus 24b display a warning. That is, in the present embodiment, the informing unit according to the present invention is the display apparatus 24b. Incidentally, the informing unit may be that performing auditory information in place of visual information.

Moreover, the control apparatus 22 controls each section so that each of the ordinary imaging, the phase contrast imaging, and the highly expanding phase contrast imaging may be executed by imaging switching instructions to the input apparatus 24a.

Here, the ordinary imaging is an imaging condition which is ordinarily performed and makes the subject H be situated closely to the X-ray detector 11. In this case, the control apparatus 22 determines the congruous X-ray detector to be the one “for ordinary imaging” so that the X-ray detector 11 for the ordinary imaging may be mounted.

In the phase contrast imaging for imaging a wide range of a hand, the diameter of the focused X-ray beam D of the X-ray source 8 is determined to be 0.1 mm and the average X-ray energy is determined to be 26 keV so that the phase contrast imaging may be executed with an enlargement factor M, which will be described later, corresponding to 1.5-3 times. Furthermore, in the phase contrast imaging, the rate of the signal value output from the X-ray detector 11 to the irradiation quantity (dose) of the X-ray irradiated to the X-ray detector 11 in comparison with the case of the ordinary imaging is determined to be moderately high. This determination arises from the decrease of the X-ray quantity reaching the X-ray detector 11 because the distance between the X-ray tube and the X-ray detector becomes long and the average X-ray energy becomes low.

In order to heighten the rate of the signal value output from the X-ray detector 11 to the dose of the radiated X-ray, the following methods can be considered: selecting the X-ray detector 11 having high sensitivity and mounting the selected X-ray detector 11 on the X-ray detector holding unit 12, heightening the amplifying ratio (gain) of the signal output from the X-ray detector 11, or combining the preceding two methods. In order to heighten the sensitivity of the X-ray detector 11, for example, a photostimulable phosphor sheet housed in the X-ray detector 11 or the light emitting layers used for the imaging panels 62 are changed to the ones emitting a high brightness light even by a low X-ray dose. Moreover, in order to heighten the gain, for example, the amplifying ratio of an electric signal in the signal detecting unit 600 is determined to be high, or the amplifying ratio of an electric signal read from the photostimulable phosphor sheet is made to be high in the reading apparatus reading the photostimulable phosphor sheet irradiated by an X-ray to output X-ray image data. Moreover, it is also adoptable to heighten the rate of amplifying the X-ray image data output from the X-ray detector 11 and the reading apparatus. In the present embodiment, the control apparatus 22 determines the congruous X-ray detector to be the one “for the phase contrast imaging” so that the X-ray detector 11 for the phase contrast imaging having the sensitivity and the gain, both being higher than those of the X-ray detector 11 for the ordinary imaging may be mounted. The phase contrast imaging is applied to the quantitative diagnosis of an osteoporosis. On the other hand, in the highly expanding phase contrast imaging applied to a quantitative diagnosis of the deformation of a bone joint for rheumatoid disease, the diameter of the focused X-ray beam D of the X-ray source 8 is determined to be 0.05 mm, and an average X-ray energy is determined to be 23 keV so that the enlargement factor M corresponds to 3-10 times and the phase contrast imaging may be executed. Furthermore, in the highly expanding phase contrast imaging, both of the sensitivity and the gain are determined to be higher than those of the phase contrast imaging. That is, the control apparatus 22 determines a congruous X-ray detector to be the one “for the highly expanding phase contrast imaging” so that the X-ray detector 11 for the highly expanding phase contrast imaging may be mounted. This arise from the facts that the subject H and the X-ray detector 11 are more distant from each other than that in the phase contrast imaging and an average X-ray energy is made to be lower in the highly expanding phase contrast imaging.

[Phase Contrast Simple X-Ray Imaging]

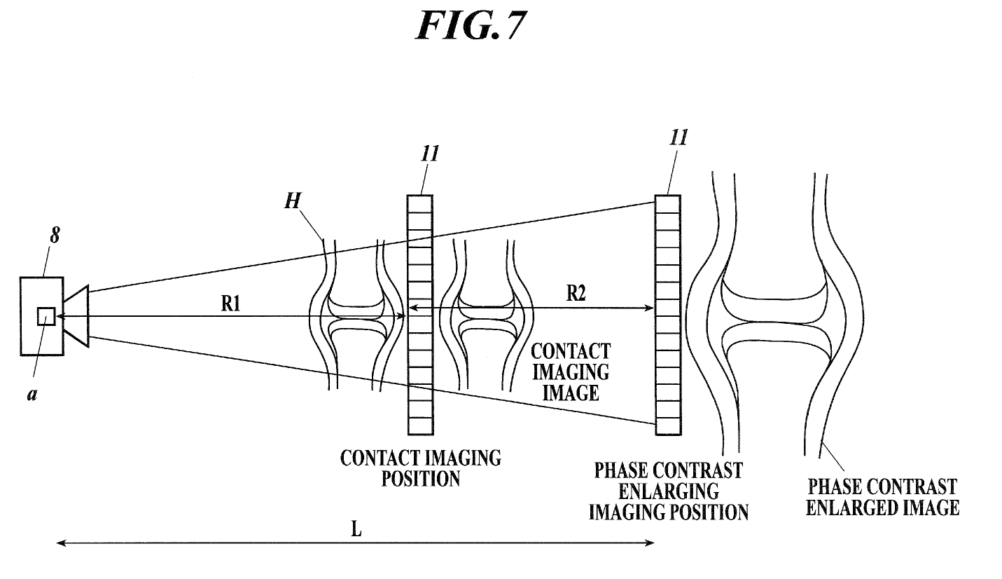

Next, phase contrast simple X-ray imaging will be described. FIG. 7 is an explanatory view of the outline of the phase contrast simple X-ray imaging. As shown in FIG. 7, the subject H is arranged at a position where the subject H and the X-ray detector 11 contact with each other in an ordinary imaging method (contact imaging position in FIG. 7). In this case, the X-ray image (latent image) recorded by the X-ray detector 11 has the size substantially equal to the life size (being the same size as that of the subject H).

On the other hand, the phase contrast simple X-ray imaging forms a distance between the subject H and the X-ray detector 11, and the X-ray detector 11 detects a latent image of an X-ray image enlarged from the life size (hereinafter referred to as an enlarged image) by an X-ray radiated from the X-ray source 8 to be in a cone beam.

Here, the enlargement factor M of the enlarged image to the life size can be obtained from the following formula (1) where the distance from the focus a of the X-ray source 8 to the subject H is R1 (m), the distance from the subject H to the X-ray image detection surface of the X-ray detector 11 is R2 (m), and the distance from the focus a of the X-ray source 8 to the X-ray image detection surface of the X-ray detector 11 is L (L=R1+R2) (m).

M=L/R1 (1)

Incidentally, it is preferable that the ratio M of the distance R2 from the subject H to the X-ray image detection surface to the distance R1 from the X-ray source 8 to the subject H is 1.5 or more.

In a phase contrast enlarged image, as shown in FIG. 8, an X-ray refracted by passing through the border of the subject H overlaps an X-ray that has not passed through the subject H on the X-ray detector 11, and the X-ray intensities in the part where the X-rays overlap each other become stronger. On the other hand, a phenomenon in which the X-ray intensity becomes weaker for the refracted X-ray in the inner part of the border of the subject H takes place. Consequently, an edge enhancement operation (also called as an edge effect), in which an X-ray intensity difference becomes wider at the border of the subject H, operates, and an X-ray image having high visibility of delineating the border portion sharply can be obtained.

If there is a restriction in the determination of a distance L like in an imaging room or the like, then the distance L (m) is fixed, and imaging can be performed under the optimum condition by changing the ratio between the distances R1 (m) and R2 (m) within the fixed distance L. For example, if L=3.0 (m) is determined, R1=1.0 and R2=2.0 are determined to the distance L. If the width of a general imaging room is considered, it is appropriate to determine the ranges of the distances R1, R2, and L as follows: 0.2≦R1≦2.0, 0.3≦R2≦2.0, and 0.8≦L≦3.0; to determine the enlargement factor M to be within a range of 1.5≦M≦10; to determine the range of the diameter of the focused X-ray beam D (μm) within a range of 5≦D≦150; and to determine the optimum distances L, R1, and R2, the enlargement factor M, and the diameter of the focused X-ray beam D empirically and experimentally while observing the relation with the visibility of the enlarged image within the above determined ranges. By determining the diameter of the focused X-ray beam D to be within the above-mentioned range, the imaging using a strong X-ray intensity to shorten the necessary time becomes possible, and the motion blurring owing to the movement of the subject H can be made to be small. Incidentally, as more preferable distances, the distances can be determined so as to satisfy the ranges: 0.5≦R1≦1.2, 0.5≦R2≦1.2, and 1.0≦L≦2.4; the enlargement factor M can be determined so as to satisfy the range of 3≦M≦8; and the diameter of the focused X-ray beam D (μm) can be determined so as to satisfy the range of 30≦D≦80.

Because a higher enlargement factor M enables the obtainment of minuter image information, the accuracy of a quantification result becomes higher. On the other hand, high enlargement factor imaging needs an X-ray tube having a smaller diameter of the focused X-ray beam, but the output of the high enlargement factor imaging becomes lower and the imaging time thereof becomes longer. Consequently, it becomes easy that the blurring owing to the movements of the subject H is caused, and the distinction of an image quality is damaged to make it impossible to perform highly accurate analyses. Consequently, the above-mentioned ranges are practically optimum.

[Image Processing Apparatus]

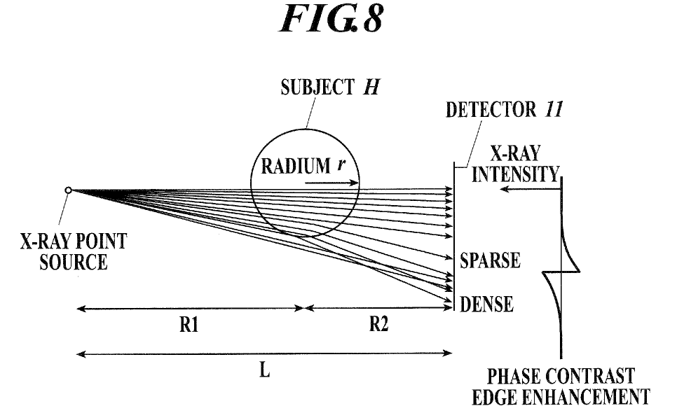

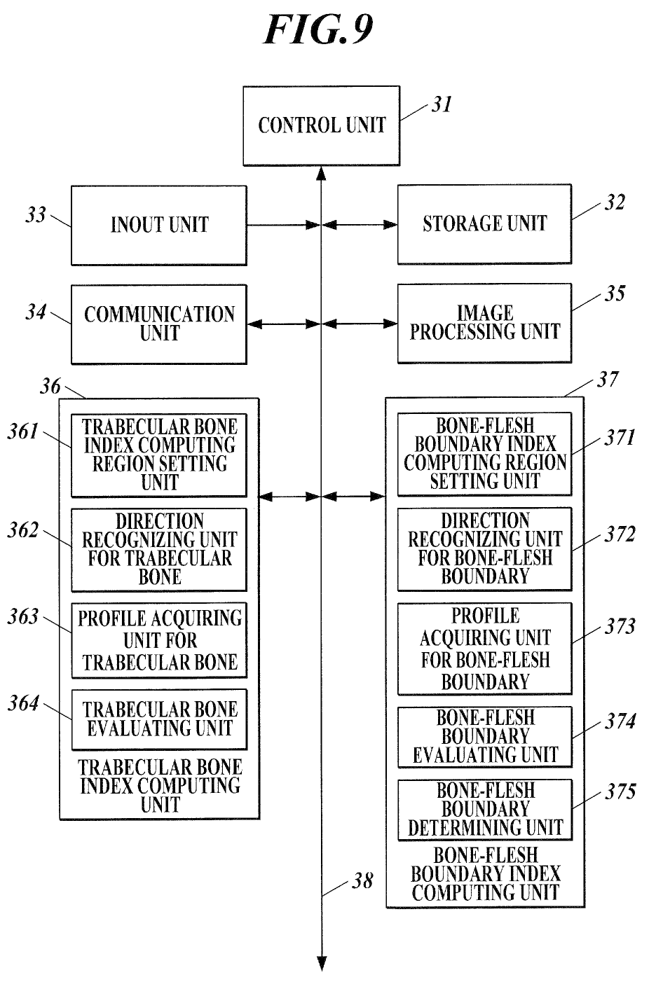

Next, the image processing apparatus 30 in the present embodiment will be described with reference to FIG. 9.

The image processing apparatus 30 according to the present invention performs image processing of the data of an X-ray image generated by the X-ray image imaging apparatus 1 to generate an image fitted to a diagnosis. The image processing apparatus 30 is composed of a control unit 31, a storage unit 32, an input unit 33, a communication unit 34, an image processing unit 35, a trabecular bone index computing unit 36, a bone-flesh boundary index computing unit 37, and the like, as shown in FIG. 9. Each section is mutually connected through a bus 38.

The control unit 31 includes a central processing unit (CPU), a random access memory (RAM), a read only memory (ROM), and the like (all not shown). The CPU performs the centralized control of the whole operation of the image processing apparatus 30 by transmitting control signals to each of the above-mentioned sections with the use of a predetermined region of the RAM as a working area in conformity with the various programs stored in the ROM or the storage unit 32 to execute various kinds of processing, such as image extracting processing, which will be described later. Incidentally, the CPUs of the image processing unit 35, the trabecular bone index computing unit 36, and the bone-flesh boundary index computing unit 37 operate in conformity with various programs similarly to the control unit 31.

The storage unit 32 is equipped with a not-shown magnetic or optical storage medium, such as a hard disc drive (HDD) and an optical disk, or a not-shown semiconductor memory fixedly or freely attachably and detachably, and stores not only various programs pertaining to the image processing apparatus 30, such as image processing programs, but also various kinds of data to be used at the time of executing these processing programs.

Moreover, in the present embodiment, the storage unit 32 stores the image data of the X-ray images imaged by the X-ray image imaging apparatus 1 and transmitted to the image processing apparatus 30. In the present embodiment, as described above, the information adding section 26 of the X-ray image imaging apparatus 1 adds imaging direction information, left and right information, the information of a person to be imaged, imaging time information, region information, and the like, as additional information, to the image data of the X-ray images, and transmits the image data to the image processing apparatus 30 in the state of including the additional information. The storage unit 32 stores these pieces of information in the state of being added to the image data.

Moreover, the storage unit 32 stores the evaluation reference value of each of the computed indices (trabecular bone indices and bone-flesh boundary indices) computed by the trabecular bone index computing unit 36 and the bone-flesh boundary index computing unit 37, and the control unit 31 compares each of the computed indices and each of the evaluation reference values to perform the evaluation of the computed index.

Moreover, the storage unit 32 stores a shape list of respective bones.

Furthermore, the storage unit 32 stores the identification information of each of the patients together with the computed indices in the state of being associated with the computed indices.

The input unit 33 is composed of, for example, a not-shown keyboard equipped with cursor keys, numeral input keys, various function keys, and the like, and a pointing device, such as a mouse, and is configured to be able to input image processing conditions and the like. The input unit 33 is configured to output an instruction signal input by a key operation of the keyboard, a mouse operation, and the like to the control unit 31. Incidentally, the image processing apparatus 30 is configured to specify (evaluation object bone specifying instruction) an evaluation object bone to which the evaluation of bone erosion among bones displayed in a phase contrast image by an operator's operation of the input unit 33.

The communication unit 34 is composed of a network interface and the like, and performs the transmission and the reception of data with external equipment, such as the X-ray image imaging apparatus 1, the image output apparatus 50, and the like, all connected to the network N, through the switching hub. That is, the communication unit 34 receives the image data of an X-ray image generated by the X-ray image imaging apparatus 1 through the network N, and suitably transmits the image data of an image to which the image processing thereof has been completed to the external apparatus, such as the image output apparatus 50.

[Trabecular Bone Index]

The trabecular bone index computing unit 36 determines a trabecular bone index computing region for computing a trabecular bone index indicating the state of a trabecula, and computes a trabecular bone index from the image data in the trabecular bone index computing region. To put it concretely, the trabecular bone index computing unit 36 acquires an X-ray intensity profile to the positions in two or more directions intersecting with each other from the image data in the trabecular bone index computing region, and computes a trabecular bone index on the basis of the X-ray intensity profile. Here, in the present embodiment, the longitudinal direction in the trabecular bone index computing region and the lateral direction perpendicular to the longitudinal direction are exemplified as the two or more intersecting directions, but the two or more intersecting directions are not limited to the above-mentioned ones.

Then, the trabecular bone index computing unit 36 is provided with a trabecular bone index computing region determining (setting) unit 361, a direction recognizing unit for trabecular bone 362, a profile acquiring unit for trabecular bone 363, and a trabecular bone evaluating unit 364.

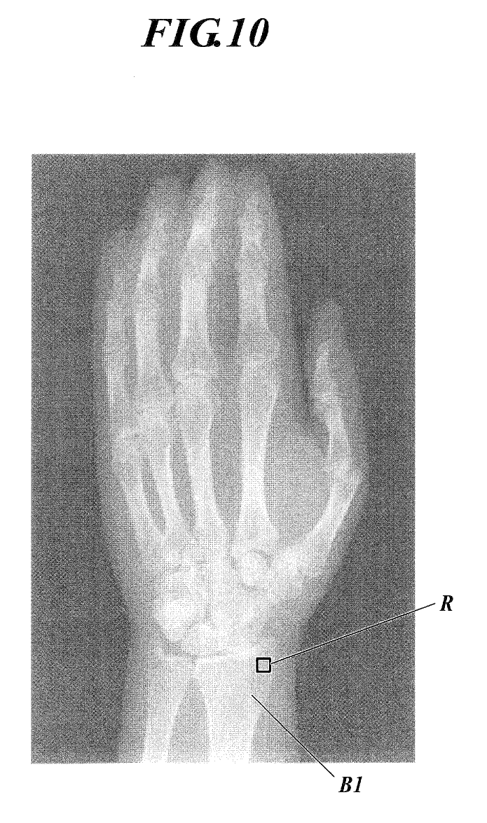

The direction recognizing unit for trabecular bone 362 selects a bone to be an evaluation bone from the respective bones in a phase contrast image detected by the X-ray detector 11, and judges the length and breadth directions of the bone. As shown in FIG. 10, when a phase contrast image G1 of a hand is acquired, the direction recognizing unit for trabecular bone 362 recognizes the shape of each bone in the image. As the recognition method, for example, there is a method of recognizing the shape by discriminating a bone portion from a flesh portion from an X-ray intensity profile to follow the border of a bone. After the shape recognition, the direction recognizing unit for trabecular bone 362 compares the recognized shape with the shape list of respective bones in the storage unit 32 to specify the kind of the respective bones in the image. When the specification of the shape has been completed, the direction recognizing unit for trabecular bone 362 selects a bone to be an evaluation object (a bone in which the symptoms of an osteoporosis easily appear (for example, a radial bone B1)). After that, the direction recognizing unit for trabecular bone 362 judges the length and breadth directions of the radial bone B1 in the phase contrast image on the basis of the shape list of the radial bone in the storage unit 32. To put it concretely, as shown in FIG. 11, as for a radial bone B2 in the shape list, the central axis along the lengthwise direction is set to a longitudinal direction T1, and the direction perpendicular to the longitudinal direction T1 is set to a lateral direction T2. Then, the direction recognizing unit for trabecular bone 362 detects the gradients of both of the radial bone B1 in the image and the radial bone B2 in the shape list by superimposing them, and determines the length and breadth directions of the radial bone B1 in the image by correcting the length and breadth directions of the radial bone B2 in the shape list by the use of the gradients.

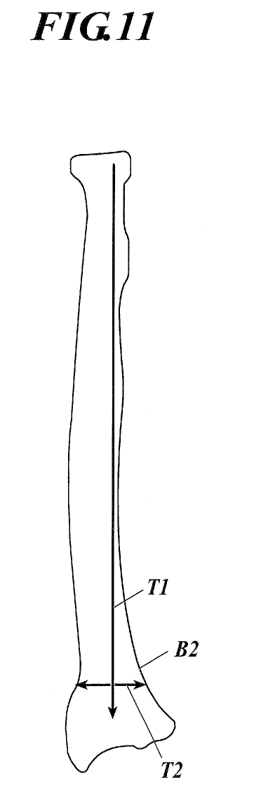

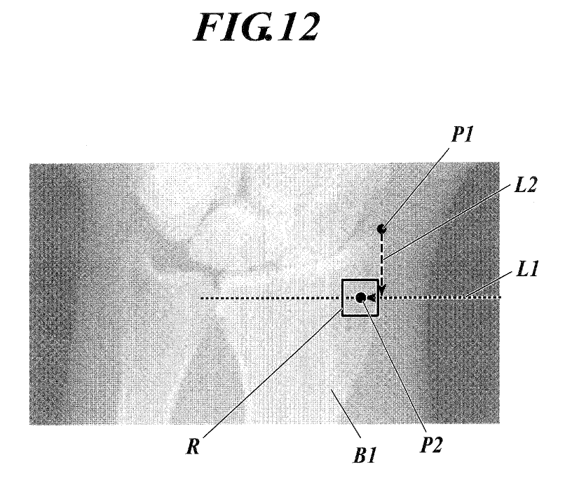

The trabecular bone index computing region determining unit 361 determines the region for computing a trabecular bone index from the phase contrast image of the radial bone B1 having the length and breadth directions specified by the direction recognizing unit for trabecular bone 362 on the basis of a first region determination method. As the first region determination method, various methods can be considered. For example, it is possible to specify a rectangular frame with the input unit 33 to determine the trabecular bone index computing region, or to automatically determine the trabecular bone index computing region by performing an image analysis of an X-ray image. In the case of performing the automatically determination, for example, as shown in FIG. 12, a position (line L1) below a pointed end P1 of the radial bone B1 in the phase contrast image by a first predetermined distance (for example, 10 mm), and a point shifted to the inner part from the point of intersection of the line L1 and a line L2 drawn from the pointed end P1 into the longitudinal direction by a second predetermined distance (for example, 5 mm) is determined as a central point P2 in a trabecular bone index computing region R. The trabecular bone index computing region determining unit 361 determines a regular square having a predetermined side length (for example, 1 cm) around the central point P2 as the trabecular bone index computing region R. Here, a couple of opposed sides of the trabecular bone index computing region R is set to be parallel to the longitudinal direction or lateral direction.

Incidentally, the first predetermined distance, the second predetermined distance, and the predetermined side length are values to be determined by various experiments, simulation, and the like.

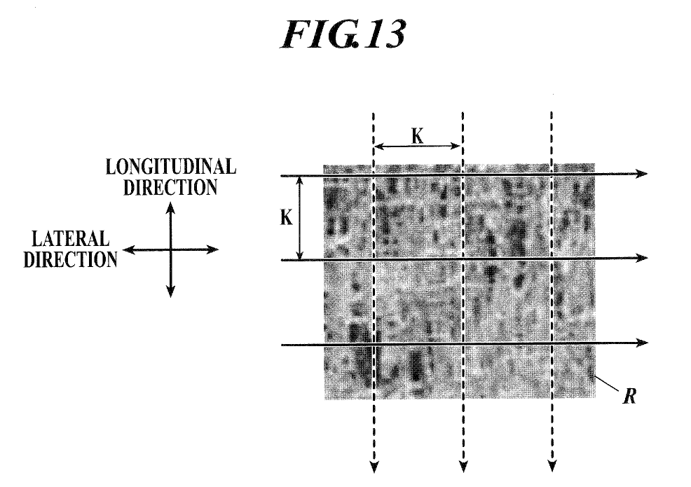

The profile acquiring unit for trabecular bone 363 acquires an X-ray intensity profile in the longitudinal direction and an X-ray intensity profile in the lateral direction in the trabecular bone index computing region R determined by the trabecular bone index computing region determining unit 361. To put it concretely, as shown in FIG. 13, the profile acquiring unit for trabecular bone 363 acquires the X-ray intensity profile in each of the length and breadth directions on the basis of the X-ray signal intensities in the trabecular bone index computing region R in a phase contrast image. A plurality of X-ray intensity profiles is acquired from the trabecular bone index computing region R at equal intervals K in each of the longitudinal direction and the lateral direction.

Incidentally, although the present embodiment uses an actually measured X-ray intensity profile for one line as the X-ray intensity profile for one line at the time of computing the trabecular image number, which will be described later, an average value of the actually measured X-ray intensity profiles for continuous plural lines may be used as the X-ray intensity profile for one line at the time of computing the trabecular image number. By such averaging, the trabecular image number can be computed by using an X-ray intensity profile including reduced noises, and the computation accuracy can be heightened. Also in this case, it is preferable to use a plurality of averaged X-ray intensity profiles.

The trabecular bone evaluating unit 364 measures the trabecular image number in the longitudinal direction and the trabecular image number in the lateral direction from each of the X-ray intensity profile in the longitudinal direction and the X-ray intensity profile in the lateral direction, and obtains the relation between the length and breadth directions of the trabecular image numbers on the basis of the measurement results. FIG. 14 shows an example of the X-ray intensity profile for one line in the longitudinal direction or the lateral direction. The trabecular bone evaluating unit 364 determines a reference line J from an X-ray intensity profile F for one line acquired by the profile acquiring unit for trabecular bone 363. To put it concretely, the reference line J multiplies the difference between the maximum signal value Fmax and the minimum signal value Fmin of the X-ray intensity profile F for one line by 0.5, and the reference line J can be obtained by adding the obtained value to the minimum signal value Fmin. The trabecular bone evaluating unit 364 measures the trabecular image numbers in the longitudinal direction and the lateral direction on the basis of the reference line J and the X-ray intensity profile F. To put it concretely, the trabecular bone evaluating unit 364 recognizes the parts convex downward from the reference line J (Q1, Q2, Q3, and Q4 in FIG. 14) as trabeculae, and measures the number of trabeculae based on the number of the parts in the X-ray intensity profile F for one line. Incidentally, the parts that have not two intersection points to the reference line J (for example, the pats q1 and q2 in FIG. 14) are not recognized as trabeculae.

Moreover, as shown in FIG. 15, the trabecular bone evaluating unit 364 measures the interval H1 between two intersection points of the parts recognized as a trabecula with the reference line J as the width of the trabecular image, and measures the center distance H2 of the widths of trabecular images of the adjoining trabeculae as the distance between trabecular images. The trabecular bone evaluating unit 364 measures a distance H3 from the reference line J to the lowest signal value in a trabecula as the depth of a trabecular image.

When the trabecular bone evaluating unit 364 measures the trabecular image number, the width of a trabecular image, the distance between trabecular images, and the depth of a trabecular image form all of the X-ray intensity profiles in the longitudinal direction and the lateral direction, the trabecular bone evaluating unit 364 computes each representative value in the trabecular bone index computing region R in each of the longitudinal direction and the lateral direction.

As for the representative value of the trabecular image number, an average value of the trabecular image numbers in all of the X-ray intensity profiles in the longitudinal direction is determined as the representative value in the longitudinal direction, and an average value of the trabecular image numbers in all of the X-ray intensity profiles in the lateral direction is determined as the representative value in the lateral direction.

Moreover, when the representative value of each of the width of a trabecular image, the distance between trabecular images, and the depth of a trabecular image is determined, the maximum value of the X-ray intensity profile for one line in the longitudinal direction is obtained every line, the average value of the obtained maximum values is determined as the representative value in the longitudinal direction, the maximum value in the X-ray intensity profile for one line in the lateral direction is obtained every line, and the average value of the maximum values is determined as the representative value in the lateral direction. Thereby, even if a peculiar value exists only in one line, the peculiar value is averaged, and the erroneous evaluation can be prevented.

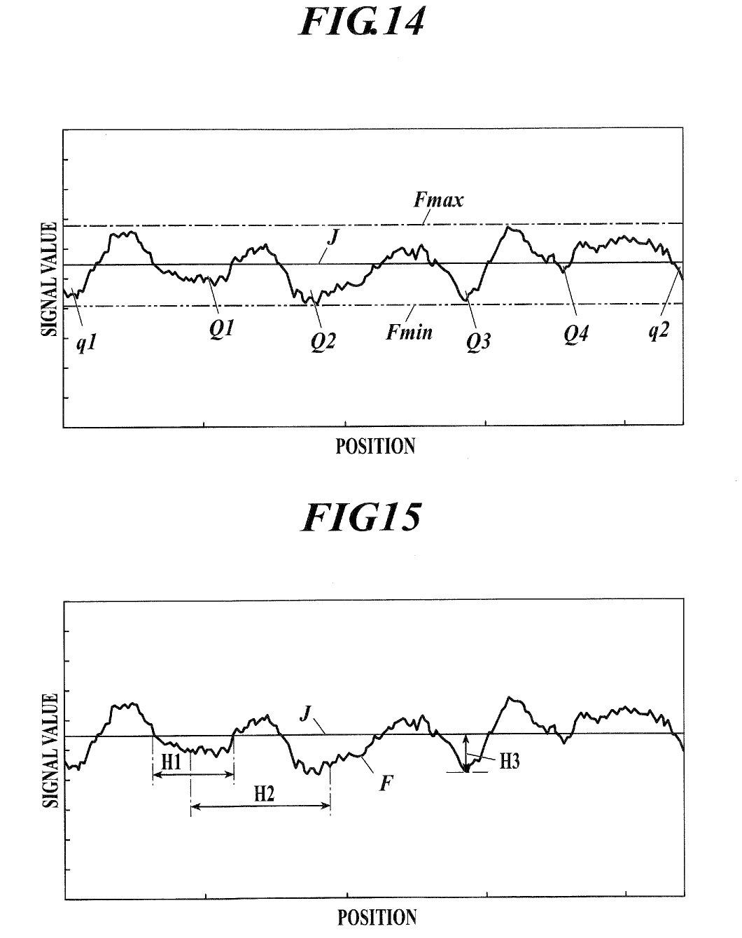

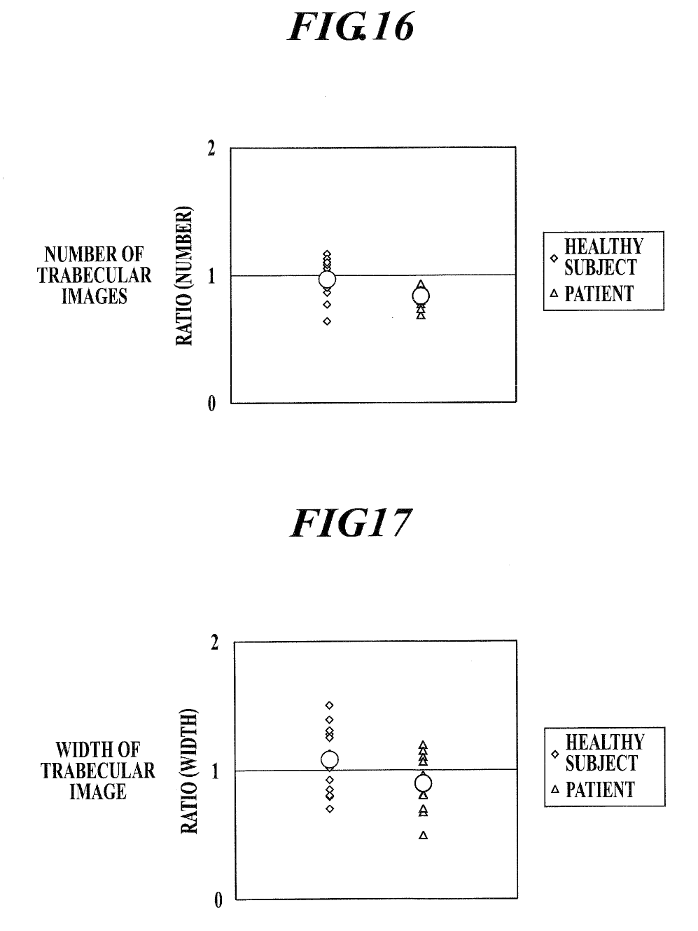

When the representative value in each of the longitudinal direction and the lateral direction is determined, the trabecular bone evaluating unit 364 computes the aspect ratio (lateral direction/longitudinal direction is determined as the aspect ratio in the present embodiment) of the representative values of the trabecular image number, the width of a trabecular image, the distance between trabecular images, and the depth of a trabecular image as a computed index. Here, FIGS. 16-19 show the comparison of aspect values of each representative value in 15 healthy subjects and 15 osteoporosis patients. Incidentally, marks o in the FIGS. 16-19 indicate average values of 15 persons.

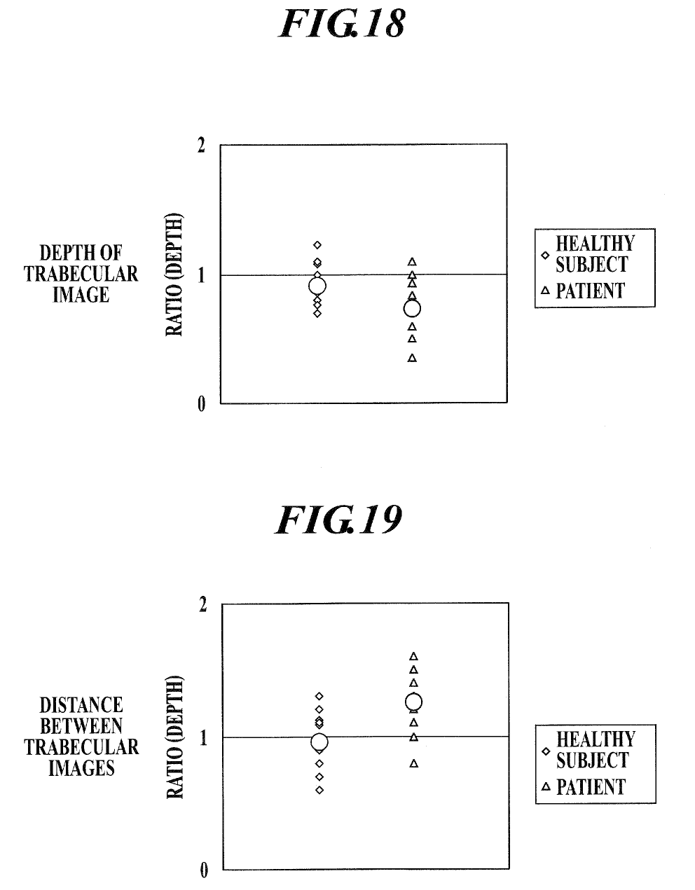

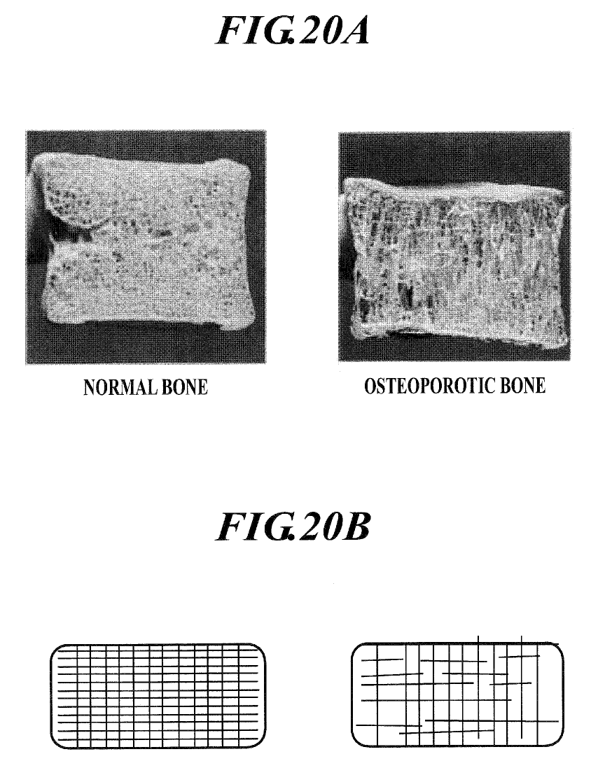

As shown in FIG. 16, in comparison to the aspect ratio of the trabecular image number of healthy subjects of about 1, the aspect ratio of patients is smaller than those of the healthy subjects to be the value under 1. FIG. 20A is a view comparatively showing trabeculae of a normal bone and trabeculae of an osteoporosis bone, and shows a real trabecula figure. FIG. 20B is a schematic view of the trabeculae. As shown in FIGS. 20A and 20B, in the case of the normal bone, the trabeculae are almost uniform in the length and breadth directions, but in the case of the osteoporosis bone, it is known that the trabeculae in the lateral direction especially decrease. The phenomenon appears in the aspect ratio of the trabecular image number.

As shown in FIG. 17, the aspect ratios of the maximum widths of trabeculae in the case of healthy subjects are the values exceeding 1, and on the other hand in the case of patients, the aspect ratios are smaller than those of the healthy subjects to be values less than 1.

As shown in FIG. 18, the aspect ratios of the maximum depths of trabeculae are values slightly less than 1 in the case of healthy subjects, and on the contrary, the aspect ratios of the patients are smaller than those of the healthy subjects to be the values greatly less than 1.

As shown in FIG. 19, the distances between trabecular images are about 1 in the case of the healthy subjects, and on the other hand, the distances of the patients are larger than those of the healthy subjects to be the values greatly larger than 1.

Incidentally, in the present embodiment, the case where 1 is stored in the storage unit 32 as the evaluation reference value of the aspect ratio of the trabecular image number will be exemplified.

Then, the control unit 31 compares each computed index computed by the trabecular bone index computing unit 36 with the evaluation reference value stored in the storage unit 32, and thereby judges the degree of the osteoporosis of the radial bone B1 falling into the trabecular bone index computing region R.

For example, if the degree of the osteoporosis is judged to a person to be imaged whose computed indices in the past are stored in the storage unit 32, the control unit 31 determines to read the past computed indices from the storage unit 32, and to comparatively display the computed indices and the computed indices obtained this time.

On the other hand, if the degree of the osteoporosis is judged to a person to be imaged whose past computed indices are not stored in the storage unit 32, the control unit 31 reads the evaluation reference value (the evaluation reference value 1 of the aspect ratio of the trabecular image number in the present embodiment) from the storage unit 32, and determines to comparatively display the evaluation reference value and the computed indices obtained this time.

Incidentally, the evaluation reference value has been obtained by the analysis of past data or the like so as to be the value enabling the judgment of the initial symptoms of the osteoporosis.

[The Other Trabecular Bone Indices: Frequency Analysis]

Moreover, although an example of computing the trabecular image number, the width of a trabecular image, the distance between trabecular images, and the depth of a trabecular image has been shown in the above-stated example, the trabecular bone indices may be computed by analyzing the X-ray intensity profile to positions by section of a frequency analysis.

[Frequency Analysis: Fourier Analysis]

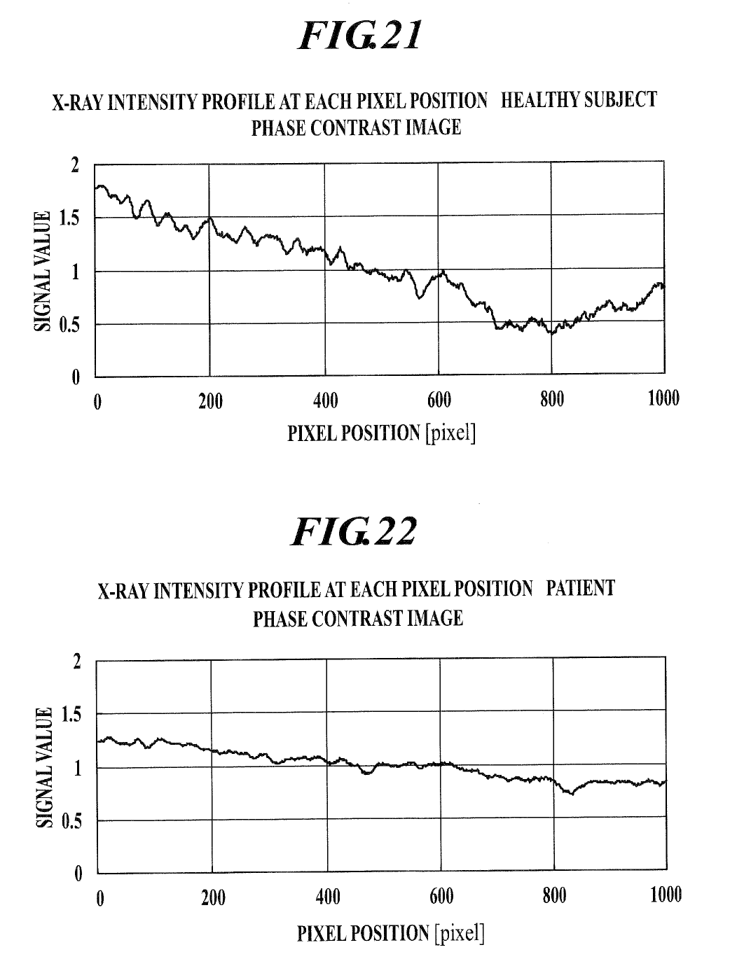

To put it concretely, the trabecular bone index computing unit 36 acquires an X-ray intensity profile based on the X-ray signal intensity at each pixel position in the longitudinal direction in the trabecular bone index computing region R and an X-ray intensity profile based on the X-ray signal intensity at each pixel position in the lateral direction. To put it concretely, as shown in FIG. 13, the trabecular bone index computing unit 36 acquires the X-ray intensity profile in each of the length and breadth directions on the basis of the X-ray signal intensity at each pixel position in the trabecular bone index computing region R in a phase contrast image. A plurality of X-ray intensity profiles are acquired from the trabecular bone index computing region R at equal intervals K in each of the longitudinal direction and the lateral direction. For example, the graph shown in FIG. 21 is an X-ray intensity profile of a healthy subject at each pixel position, and the graph shown in FIG. 22 is an X-ray intensity profile of a bone disease patient. Incidentally, the imaging conditions of a phase contrast image obtained for acquiring the X-ray intensity profiles of FIGS. 21 and 22 are: R1=0.65 m, R2=0.49 m, L=1.14 m, enlargement factor M=1.75 times, diameter of the focused X-ray beam D=0.1 mm, energy quantity E=25 keV.

Then, the Fourier analysis is performed to the X-ray intensity profiles acquired by the trabecular bone index computing unit 36 and the profile acquiring unit for trabecular bone 363 as a frequency analysis. To put it concretely, when the trabecular bone index computing unit 36 performs the Fourier analysis to the X-ray intensity profile, the trabecular bone index computing unit 36 performs the Fourier analysis by multiplying the X-ray intensity profile by a window function of the width corresponding to the actual size of the subject of 10 mm or less, for example, of the width of 256 pixels (the actual size of the subject of 6-7 mm), shifting window function by the predetermined length. The trabecular bone index computing unit 36 thus performs the Fourier analysis. Because the width of the actual size of the subject of 6-7 mm corresponds to 4-5 trabeculae, if the window function of the width or less is used, the power spectrum of 0.5-2.0 cycles/mm corresponding to a trabecula of a bone of a hand becomes easy to appear in analysis results. Incidentally, because an X-ray intensity profile is plotted by the pixel on abscissa axis, also the window function must perform conversion by the pixel to perform Fourier transformation. At this time, although the pixel size varies with apparatus, it is desirable to perform conversion so as to be a window function of the width of 10 mm or less in any pixel size.

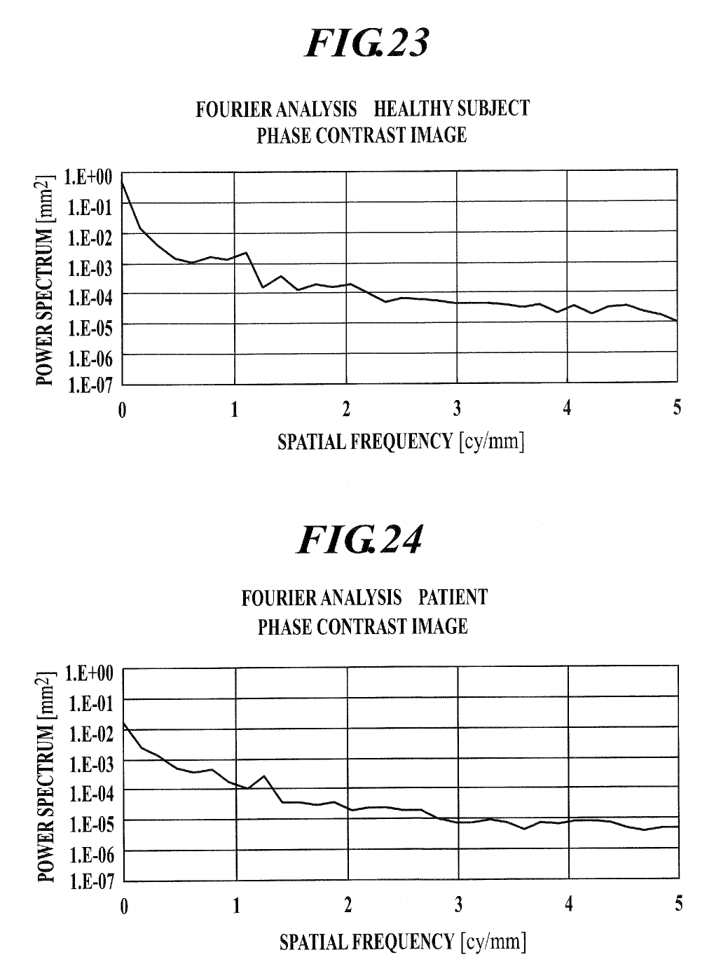

Then, for example, if the above-stated Fourier analysis is performed to the X-ray intensity profiles of FIGS. 21 and 22, then analysis results shown in FIGS. 23 and 24, respectively, each having an ordinate axis indicating power spectra and an abscissa axis indicating spatial frequencies, can be obtained. Incidentally, the ordinate axis of a graph indicating an analysis result is set to be a logarithmic axis.

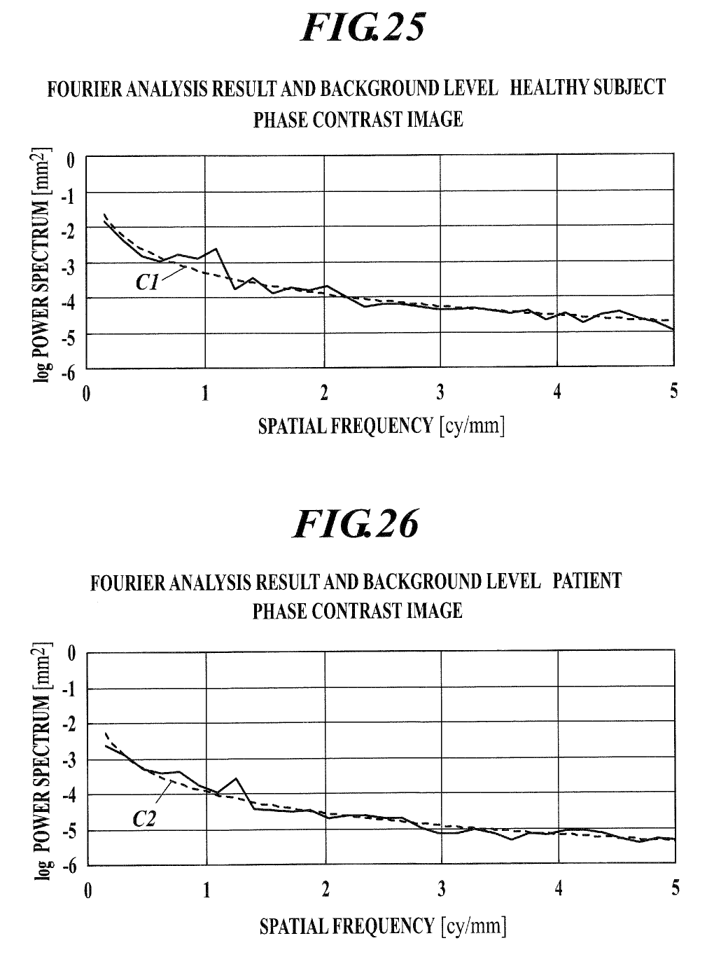

The trabecular bone index computing unit 36 furthermore computes a trabecular bone index on the basis of the result of the frequency analysis. To put it concretely, the trabecular bone index computing unit 36 subtracts a background level from a power spectrum as an analysis result of the Fourier analysis, each being in the form of a logarithm, and after that, the trabecular bone index computing unit 36 computes a trabecular bone index on the basis of the subtracted power spectrum. For example, when the analysis results shown in FIGS. 23 and 24 are obtained, the trabecular bone index computing unit 36 converts the power spectra of the analysis results into logarithms, and obtains approximate curves by performing a well-known approximate curve producing method, such as an exponential approximation, to the logarithms. The approximate curves are the background levels. FIGS. 25 and 26 are graphs superimposing approximate curves (background levels C1 and C2) on each Fourier analysis result of FIGS. 23 and 24, respectively.

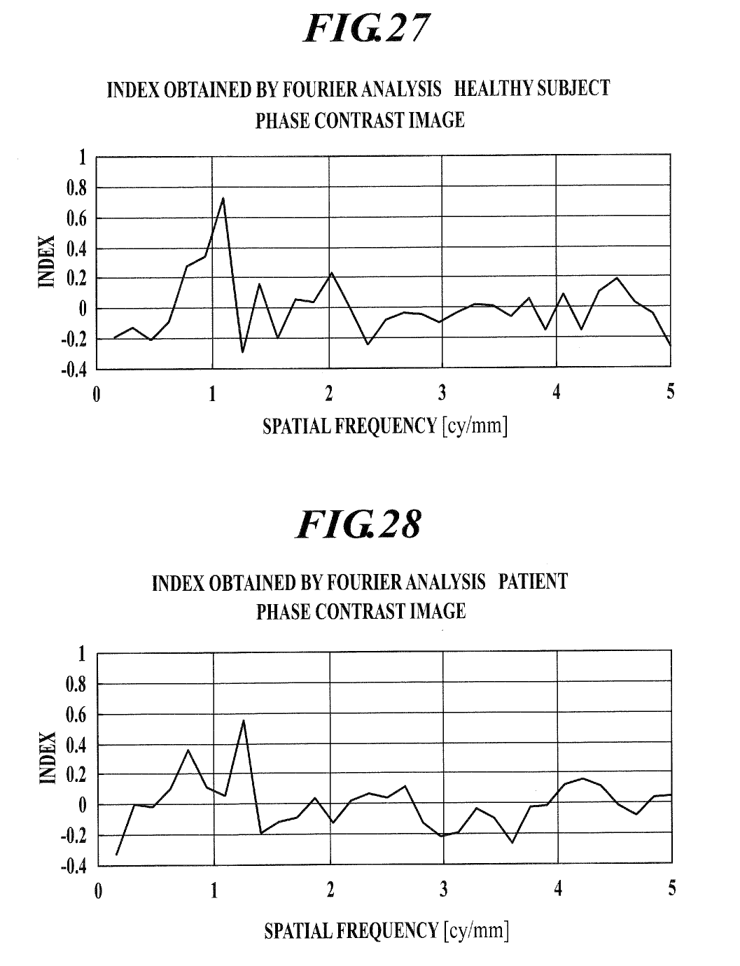

The trabecular bone index computing unit 36 subtracts the background levels C1 and C2 from the power spectra, and determines the maximum values as indices indicating the degrees of bone diseases. For example, FIGS. 27 and 28 are graphs showing the values of subtracting the background levels C1 and C2 from the power spectra of FIGS. 25 and 26, respectively. The index of a healthy subject is 0.73 (maximum value) as shown in FIG. 27. On the other hand, as shown in FIG. 28, the index of a patient is 0.55 (maximum value). The case of storing 0.6 as the evaluation reference value of an index is stored in the storage unit 32 is exemplified in the present embodiment on the basis of the above-mentioned results.

[Frequency Analysis: Wavelet Analysis]

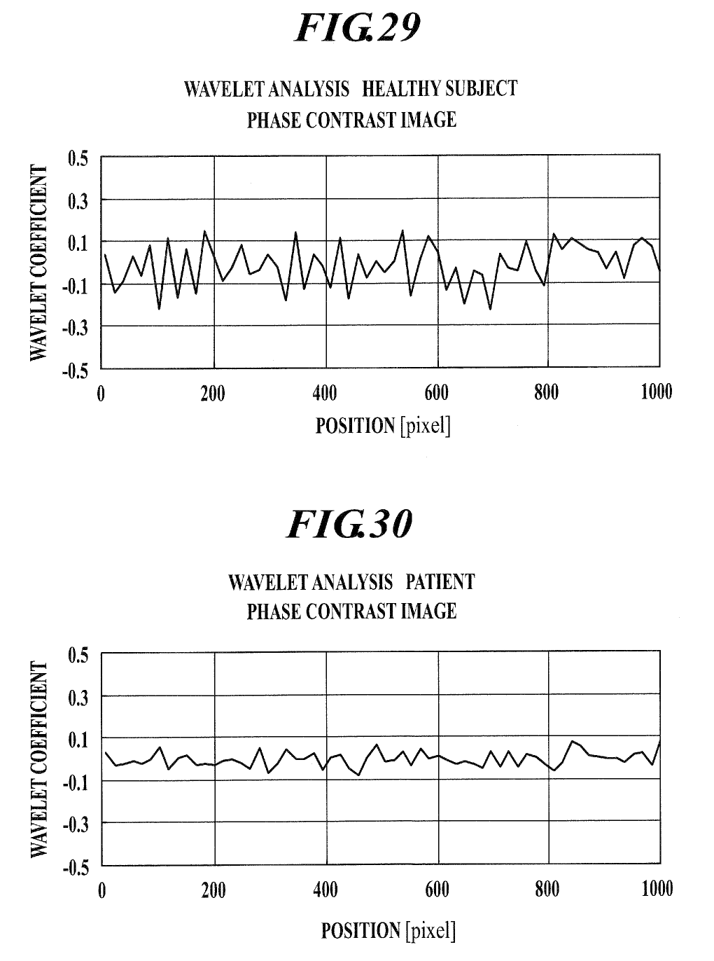

Moreover, although the case of performing the Fourier analysis to an X-ray intensity profile as the frequency analysis thereof is exemplified to be described in the above-described embodiment, a wavelet analysis may be performed. In this case, the trabecular bone index computing unit 36 performs the wavelet analysis to an X-ray intensity profile as the frequency analysis thereof. For example, if the wavelet analyses are performed to the X-ray intensity profiles of FIGS. 21 and 22, then the analysis results shown in FIGS. 29 and 30, respectively, each having wavelet coefficients plotted in the ordinate axes, and pixel positions plotted in the abscissa axes, can be obtained.

Then, the trabecular bone index computing unit 36 computes indices indicating the degrees of bone diseases on the basis of the results of the wavelet analyses. To put it concretely, the trabecular bone index computing unit 36 computes statistical values of the wavelet coefficients as computed indices from the analysis results of the wavelet analyses. Here, the statistical value is at least one of, for example, the maximum value of the wavelet coefficients, the minimum value, dispersion, standard deviation values, and counted values of a certain threshold value or more. For example, in the case of the healthy subject in FIG. 29, the maximum value of the wavelet coefficients is 0.15, the minimum value thereof is −0.22, the dispersion thereof is 0.0097, and the standard deviation value is 0.0991. On the other hand, in the case of the patient in FIG. 30, the maximum value of the wavelet coefficients is 0.08, the minimum value thereof is −0.08, the dispersion thereof is 0.0012, and the standard deviation value is 0.0348. The evaluation reference value of an index is determined on the basis of these values, and the determined evaluation reference value is stored in the storage unit 32. If each evaluation reference value based on the above-mentioned values is exemplified, then 0.1 in the case of the maximum value, −0.15 in the case of the minimum value, 0.005 in the case of the dispersion, and 0.06 in the standard deviation value. The evaluation reference value is obtained on the basis of experiments, simulations, the analysis of past data, and the like so as to be the values enabling the judgment of the existence of any disease.

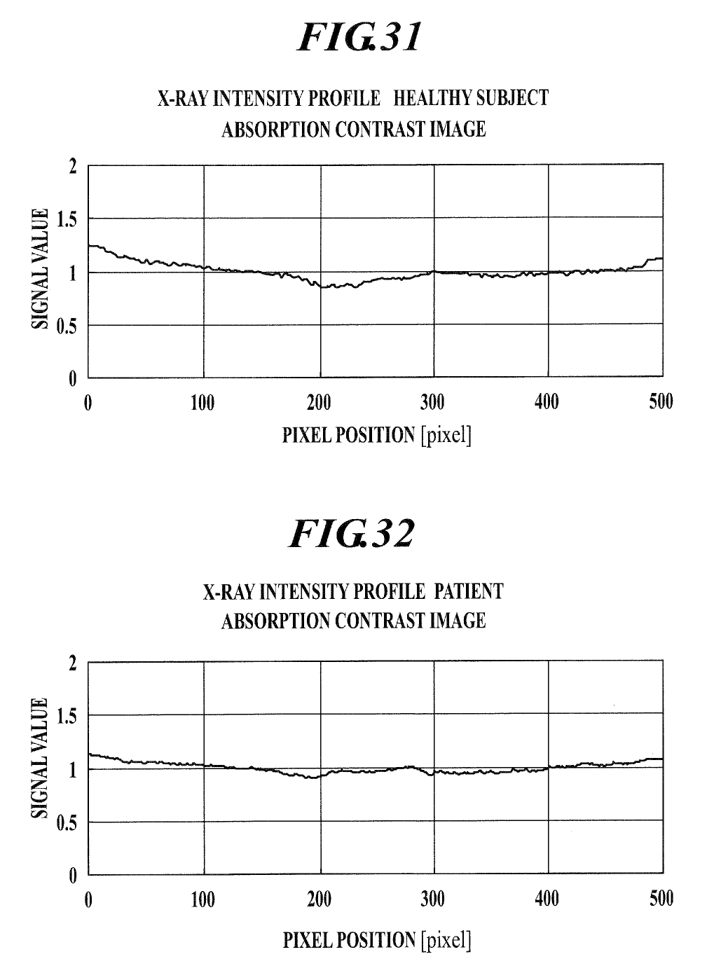

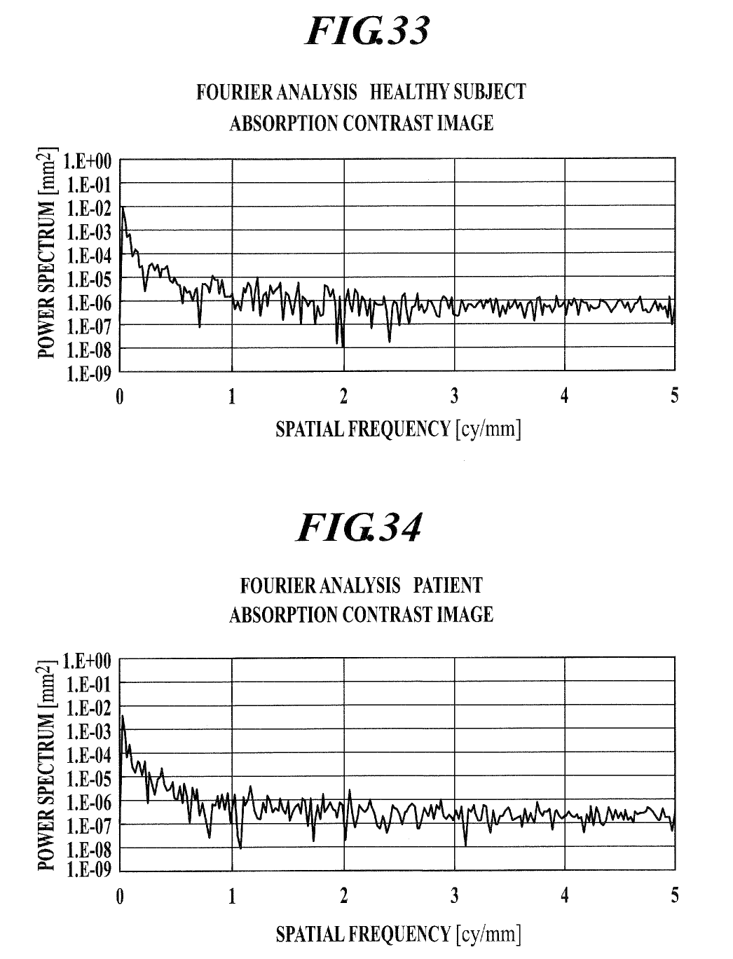

Moreover, although the present embodiment obtains an X-ray intensity profile on the basis of a phase contrast image, this is because the differences of X-ray signal intensities of a phase contrast image are more clear in comparison with the ratios of the X-ray image by the ordinary imaging to be possible to heighten the detection accuracy. For example, the same place of the subject from which the above-stated X-ray intensity profiles of FIGS. 14 and 15 were acquired was imaged by absorption contrast imaging, and an X-ray intensity profile was acquired by the method similar to that. The imaging conditions of the absorption contrast imaging were: R1=1 m, R2=0 m, the diameter of the focused X-ray beam D=1.2 mm, and the energy quantity E=33 keV. FIG. 31 is an X-ray intensity profile of a healthy subject acquired by an absorption contrast image, and FIG. 32 is an X-ray intensity profile of a patient acquired by an absorption contrast image. FIGS. 33 and 34 show the analysis result by the Fourier analyses of the X-ray intensity profiles of FIGS. 30 and 31, respectively. By comparing the analysis results of FIGS. 33 and 34, it is apparent that the differences between the analysis results of the healthy subject and the patient are not clear in comparison with the analysis results of FIGS. 23 and 24.

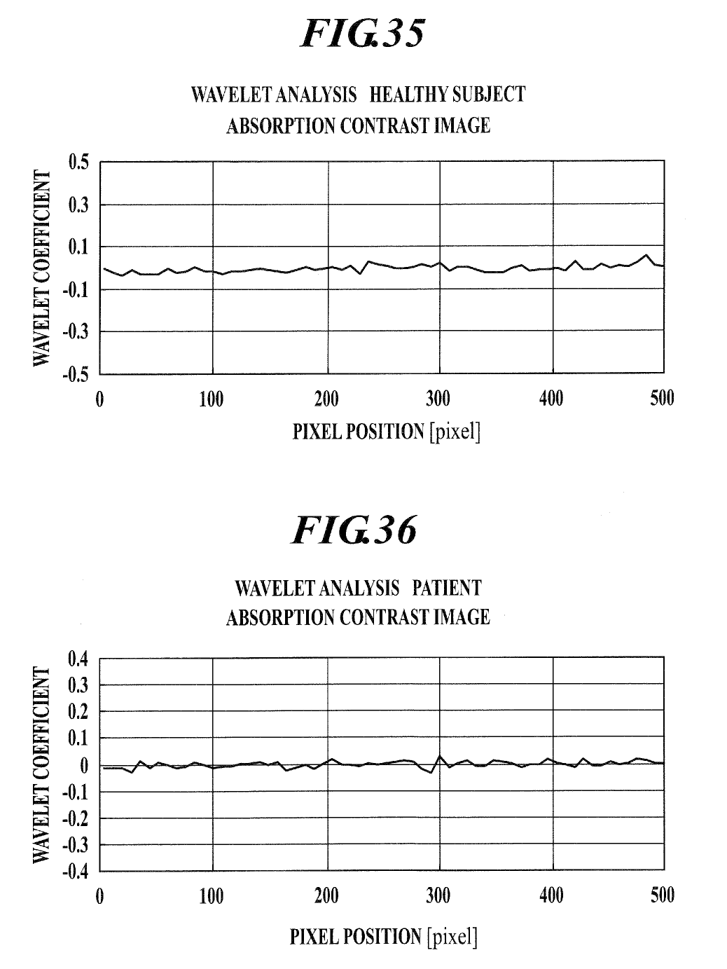

On the other hand, FIGS. 35 and 36 shown the analysis results of performing the wavelet analyses to the X-ray intensity profiles of FIGS. 31 and 32, respectively. If the above-mentioned computed indices are computed from the analysis results, then the maximum value of the wavelet coefficient of a healthy subject (FIG. 35) is 0.06, the minimum value thereof is −0.04, the dispersion thereof is 0.0003, and the standard deviation value thereof is 0.0169; the maximum value of the wavelet coefficient of a patient (FIG. 36) is 0.03, the minimum value thereof is −0.03, the dispersion thereof is 0.0001, and the standard deviation value thereof is 0.0119. As described above, differences exist in the computed indices between the healthy subject and the patient even by the absorption contrast image, but the differences are little in comparison with the differences in the above-stated phase contrast image.

As described above, by performing the frequency analysis to a phase contrast image, it becomes possible to detect a subtle difference of a symptom and an aged deterioration thereof more than an absorption contrast image.

[Bone-Flesh Boundary Index]

The bone-flesh boundary index computing unit 37 determines a bone-flesh boundary index computing region, in which bone-flesh boundary indices indicating the degrees of bone erosion, an osteophyte, and the like are computed, and computes the bone-flesh boundary indices from the image data in the bone-flesh boundary index computing region. To put it, concretely, the bone-flesh boundary index computing unit 37 acquires an X-ray intensity profile to the positions of a bone portion in the neighborhood of a bone-flesh boundary in the subject H from the image data in the bone-flesh boundary index computing region, and computes the trabecular bone indices on the basis of the X-ray intensity profile.

Then, as shown in FIG. 9, the bone-flesh boundary index computing unit 37 is provided with a bone-flesh boundary index computing region determining (setting) unit 371, a direction recognizing unit for bone-flesh boundary 372, a profile acquiring unit for bone-flesh boundary 373, a bone-flesh boundary evaluating unit 374, and a bone-flesh boundary determining unit 375.

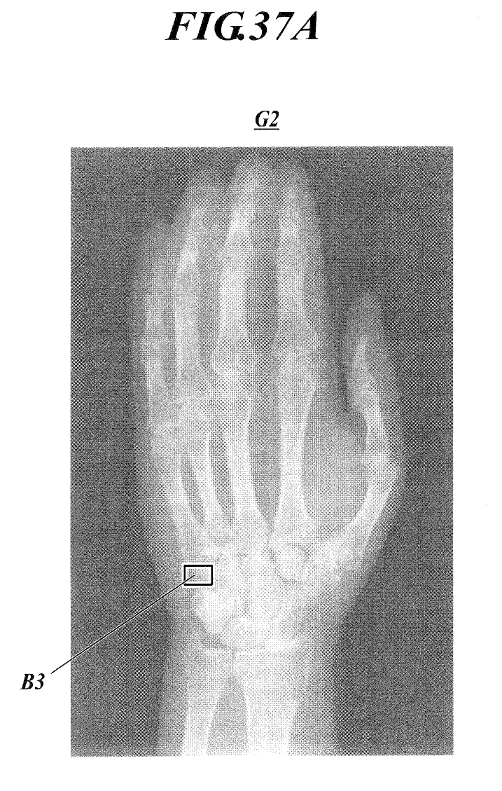

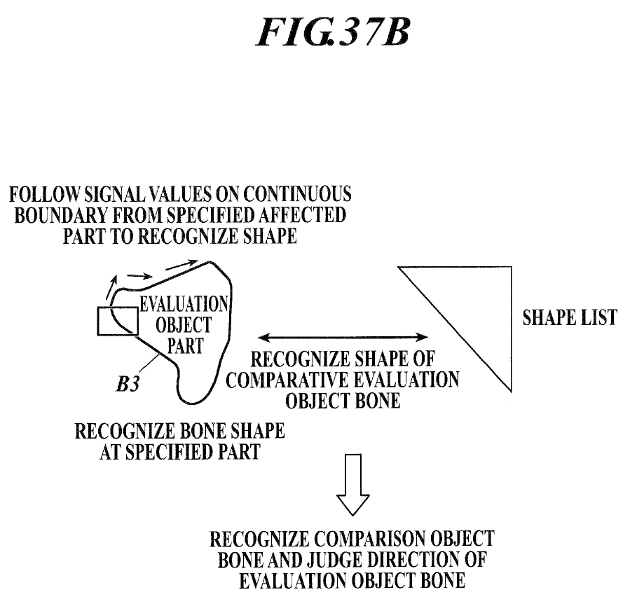

The bone-flesh boundary index computing region determining unit 371 determines a region for computing bone-flesh boundary indices from a phase contrast image of an evaluation object bone B3 by a second region determination method different from the first region determination method. When an evaluation object bone specifying instruction is input from an operator to the input unit 33, the bone-flesh boundary index computing region determining unit 371 specifies an evaluation object bone from the respective bones in a phase contrast image on the basis of the content of the instruction to recognize the shape of the specified evaluation bone. To put it concretely, as shown in FIG. 37A, when a phase contrast image G2 of a hand is acquired, the bone-flesh boundary index computing region determining unit 371 recognizes the shape of the evaluation object bone B3 in the image. The recognition method is, for example, as shown in FIG. 37B, to follow the border of the evaluation object bone B3 by judging bone portions and flesh portions from the X-ray intensity profile, and thereby to recognize the shape. After the shape recognition, the bone-flesh boundary index computing region determining unit 371 compares the recognized shape with the shape list of each bone in the storage unit 32 to recognize the shape and the direction of the evaluation object bone B3.

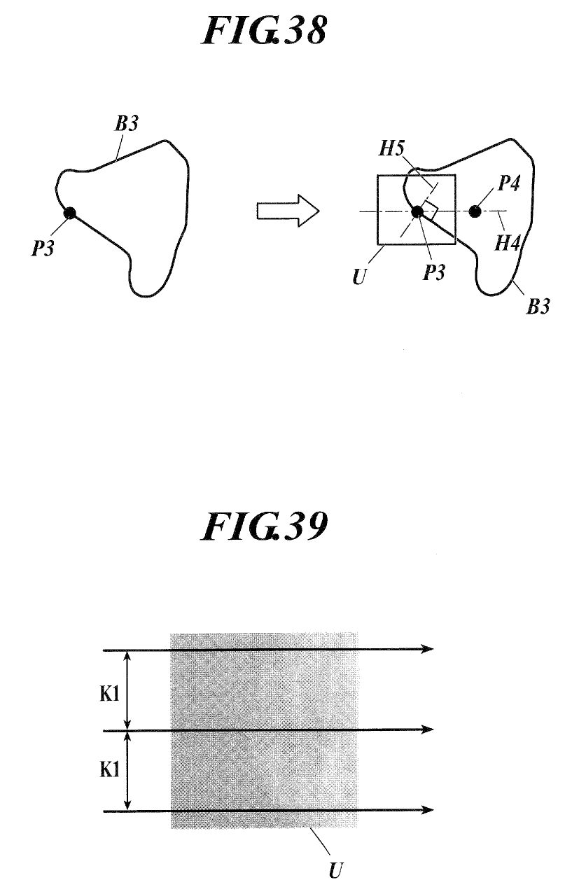

Various methods can be considered as the second region determination method. For example, the method of specifying a rectangular frame with the input unit 33 to determine a bone-flesh boundary index computing region, or the method of performing an image analysis of an X-ray image to automatically determine a bone-flesh boundary index computing region can be considered. If the bone-flesh boundary index computing region is automatically determined, the bone-flesh boundary index computing region must be determined so that at least the border of the evaluation object bone B3 falls into the bone-flesh boundary index computing region. For example, as shown in FIG. 38, a rectangular frame is specified around a predetermined position P3 on the border of the evaluation object bone B3 in a phase contrast image, and the region within the rectangular frame is determined as a bone-flesh boundary index computing region U.

When the bone-flesh boundary index computing region determining unit 371 determines the bone-flesh boundary index computing region U, the direction recognizing section for bone-flesh boundary 372 judges profile directions of the evaluation object bone B3 from the bone-flesh boundary index computing region U. To put it concretely, as shown in FIG. 38, as the profile directions, a direction H4 that faces from the outside toward gravity center P4, crossing the edge of the evaluation object bone B3, a direction H5 perpendicular to the edge of the evaluation object bone B3, and the like can be given.

The profile acquiring section for bone-flesh boundary 373 acquires X-ray intensity profiles in the bone-flesh boundary index computing region U on the basis of the profile directions judged by the direction recognizing section for bone-flesh boundary 372. To put it concretely, as shown in FIG. 39, the profile acquiring section for bone-flesh boundary 373 acquires the X-ray intensity profiles in the profile directions (FIG. 39 exemplifies the case where the profile directions and the lateral direction of the bone-flesh boundary index computing region U are parallel) on the basis of the X-ray signal intensities in the bone-flesh boundary index computing region U of the phase contrast image. Incidentally, a plurality of X-ray intensity profiles is acquired at equal intervals K1 from the bone-flesh boundary index computing region U.

Incidentally, although the present embodiment uses an actually measured X-ray intensity profile for one line as the X-ray intensity profile for one line at the time of determining a bone-flesh boundary part, which will be described later, an average value of actually measured X-ray intensity profiles for a plurality of continuous lines may be the X-ray intensity profile for one line at the time of determining the bone-flesh boundary part. By averaging in this manner, it is possible to determine the bone-flesh boundary part on the basis of an X-ray intensity profile including reduced noises, and consequently the accuracy thereof can be more heightened.

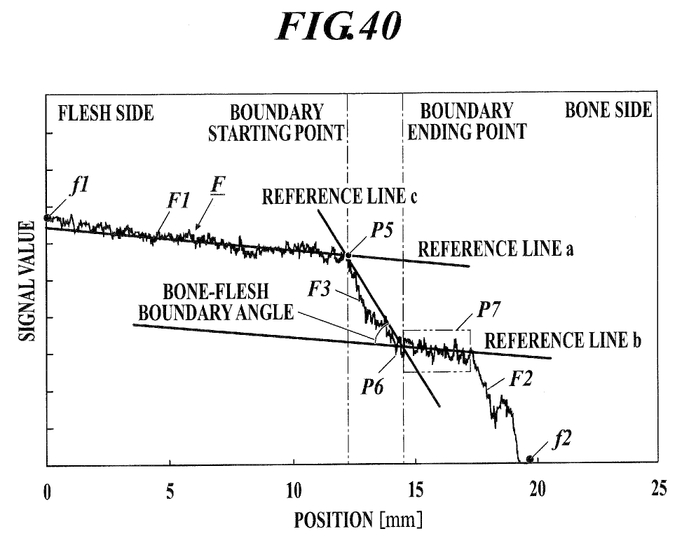

The bone-flesh boundary determining unit 375 determines a bone-flesh boundary part from the X-ray intensity profile obtained by the profile acquiring section for bone-flesh boundary 373. FIG. 40 is a view showing an example of an X-ray signal profile. As shown in FIG. 40, the signal values of a profile F1 of the X-ray intensity profile F on a flesh side differ from those of a profile P2 on a bone side, and steep changes appear between both the sides (bone-flesh boundary part F3). The bone-flesh boundary determining unit 375 scans the X-ray intensity profile F from the bone side end f1 toward the flesh side, and determines a point at which a displacement of a defined scope or more arises within a predetermined position interval as a boundary starting point P5. Moreover, the bone-flesh boundary determining unit 375 scans the X-ray intensity profile F from a flesh side end f2 toward the bone side, and specifies a part P7 at which the displacement within the predetermined position interval falls into the defined scope on the bone side in relation to the boundary starting point P5. The bone-flesh boundary determining unit 375 determines the flesh side end of the part P7 as a boundary ending point P6. The bone-flesh boundary determining unit 375 determines the range from the boundary starting point P5 to the boundary ending point P6 as the bone-flesh boundary part.

The bone-flesh boundary evaluating unit 374 computes an angle index value indicating an angle formed in the X-ray intensity profile in the bone-flesh boundary part determined by the bone-flesh boundary determining unit 375. The bone-flesh boundary evaluating unit 374 determines various reference lines to the X-ray intensity profile in order to detect the angle index value. For example, the bone-flesh boundary evaluating unit 374 determines an approximate straight line of the X-ray intensity profile on the flesh side in relation to the boundary starting point P5 which approximate straight line crosses the boundary starting point P5 as a reference line a. Moreover, the bone-flesh boundary evaluating unit 374 determines an approximate straight line of the X-ray intensity profile in the part P7 which approximate straight line crossing the boundary ending point P6 as a reference line b. Then, the bone-flesh boundary evaluating unit 374 determines a line connecting the boundary starting point P5 with the boundary ending point P6 as a reference line c.

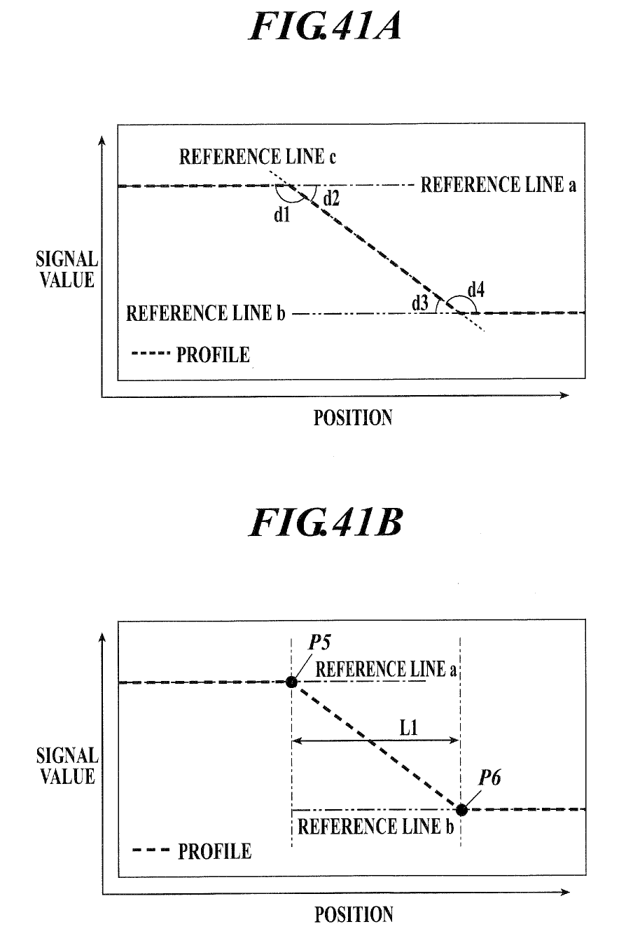

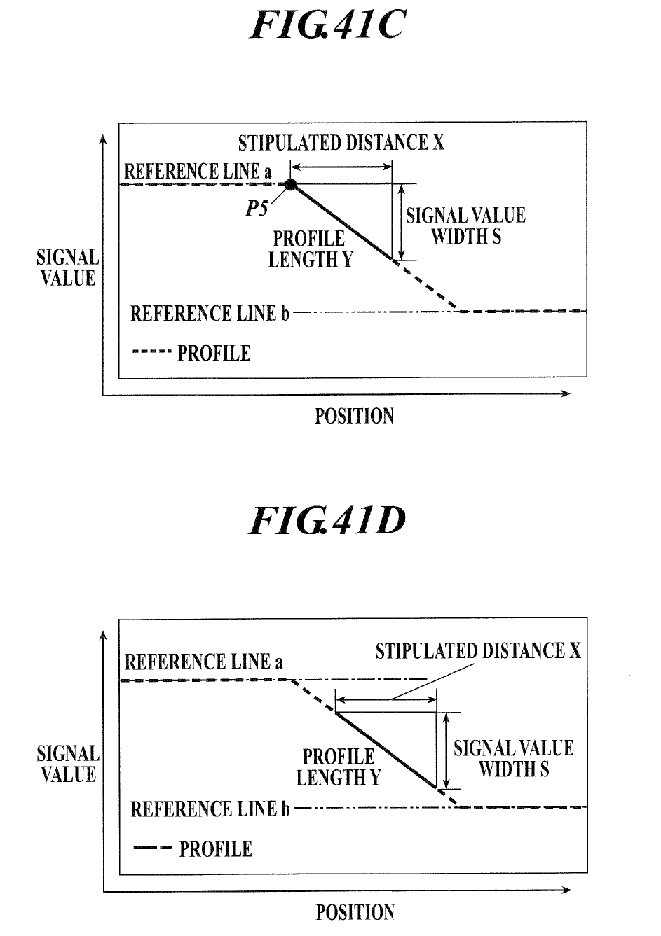

When the bone-flesh boundary evaluating unit 374 completes the determinations of the reference lines a, b, and c, the bone-flesh boundary evaluating unit 374 computes an angle index value as the bone-flesh boundary shape data indicating the shape of the bone-flesh boundary on the basis of the respective reference lines a, b, and c. As the angle index value, any value indicating an angle formed by the X-ray intensity profile may be adopted, and for example, the following values can be given. FIG. 41 is an explanatory view showing the kinds of the angle index values. As shown in FIG. 41A, an acute angle d2 or an obtuse angle d1 formed by the reference line a and the reference line c or an acute angle d3 or an obtuse angle d4 formed by the reference line b and the reference line c may be determined as the angle index value. Moreover, as shown in FIG. 41B, an interval L1 between the boundary starting point P5 and the boundary ending point P6 may be determined as the angle index value. Then, as shown in FIG. 41C, a signal value width S obtained by shifting a stipulated distance X from the boundary starting point P5 to the bone side or a profile length Y may be determined as the angle index value. Incidentally, as shown in FIG. 41D, the starting point of the stipulated distance X may be any point on the X-ray intensity profile in the bone-flesh boundary part in place of the boundary starting point P5.

Incidentally, in the present embodiment, the bone-flesh boundary evaluating unit 374 computes the acute angle d3 formed by the reference line b and the reference line c in FIG. 41A as the angle index value.

When the bone-flesh boundary evaluating unit 374 has computed the angle index values from all of the X-ray intensity profiles acquired from the bone-flesh boundary index computing region U, the bone-flesh boundary evaluating unit 374 analyzes the angle index values to compute a representative value in the bone-flesh boundary index computing region U. To put it concretely, the bone-flesh boundary evaluating unit 374 determines the average value of the angle index values acquired from the respective X-ray intensity profiles as the representative value.

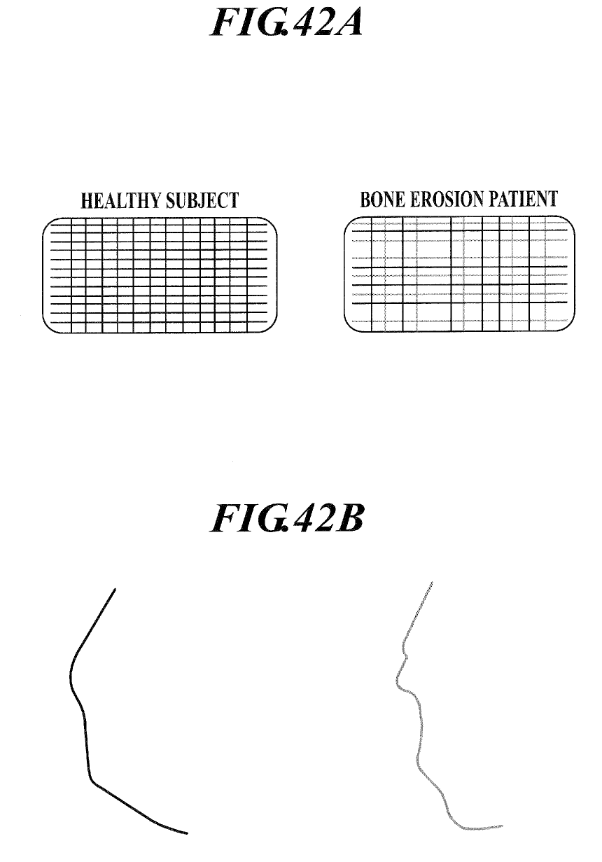

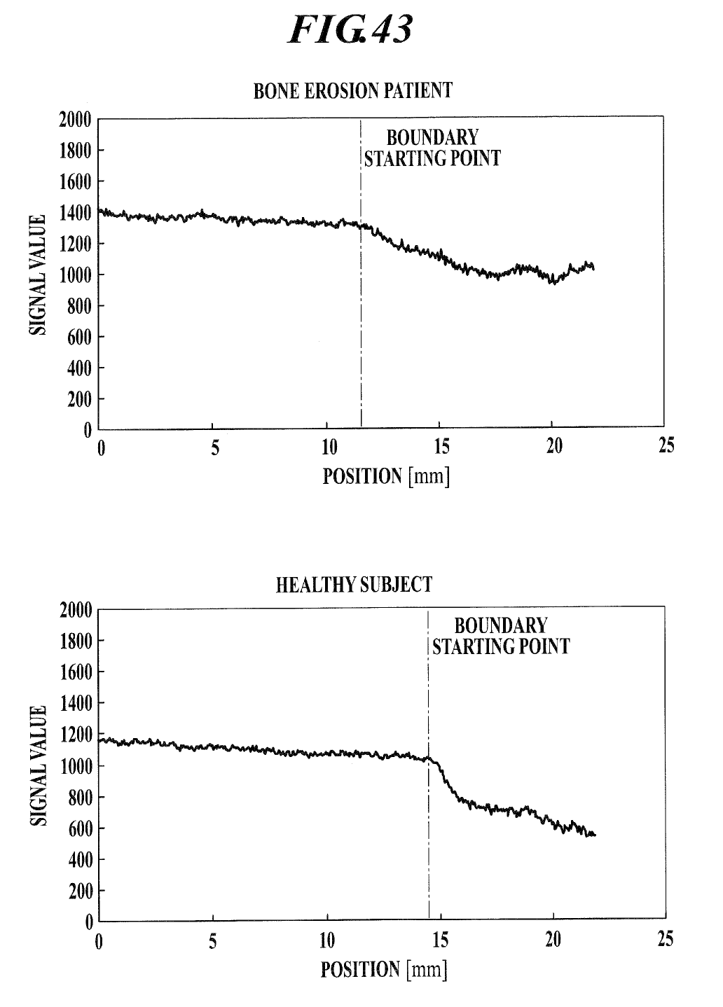

When the bone-flesh boundary evaluating unit 374 has determined the representative value, the bone-flesh boundary evaluating unit 374 evaluates the representative value. Here, FIGS. 42A and 42B are explanatory views comparatively displaying a bone state of a healthy subject and a bone state of a bone erosion patient. FIG. 42A shows the trabecula states of the respective healthy subject and the bone erosion patient. As shown in FIG. 42A, it can be known that the trabeculae decrease in the bone erosion patient. On the other hand, FIG. 42B shows the states of the bone borders of the respective healthy subject and the bone erosion patient. As shown in FIG. 42B, the bone border of the bone erosion patient lacks distinction, and the line gets out of shape. From these facts, the angle in the bone-flesh boundary part of the bone erosion patient is smaller than that of the healthy subject can be concluded by comparing the X-ray intensity profile of the bone of the healthy subject and the X-ray intensity profile of the bone erosion patient [symbol] X-ray intensity profile (see FIG. 43. The circumferences on the right sides of the boundary starting points in FIG. 43 are the bone-flesh boundary parts).

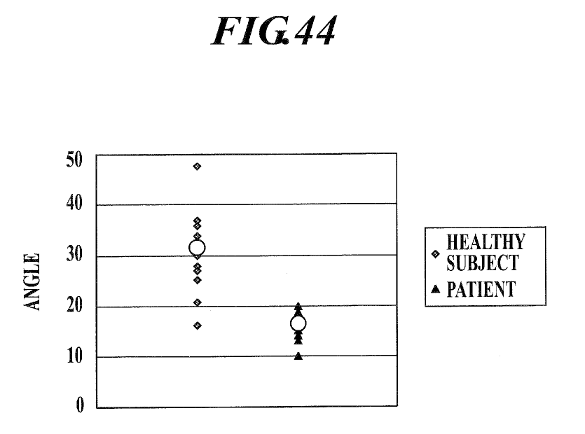

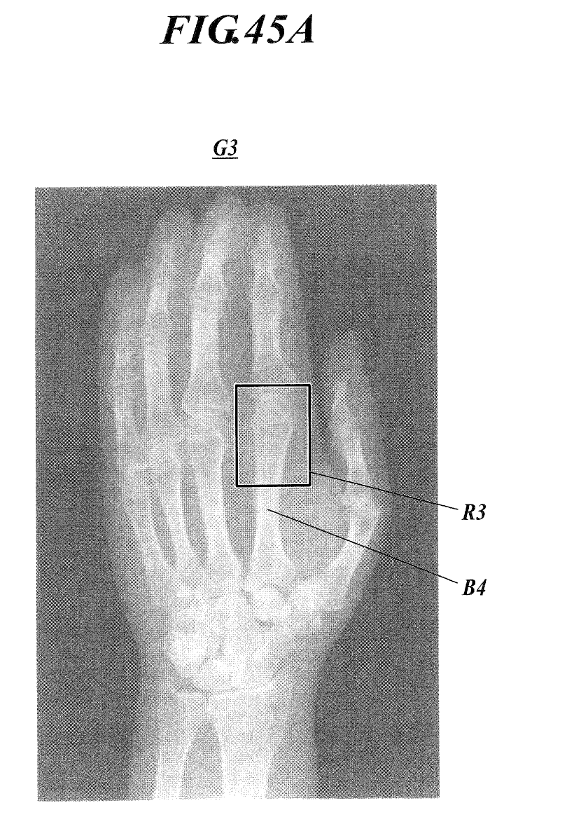

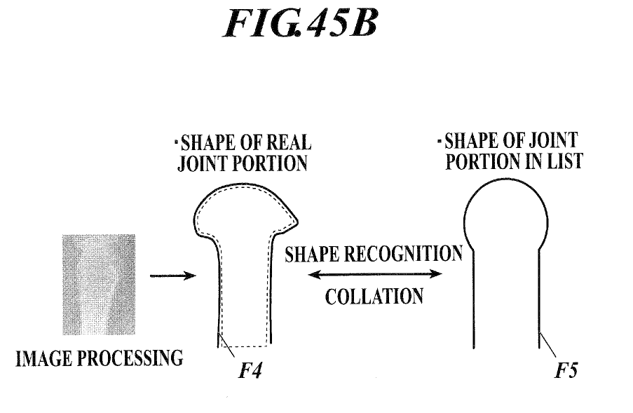

FIG. 44 shows comparison of the representative values of the angle index values of 15 healthy subjects and 15 bone erosion patients. Incidentally, the marks o in the figure indicate the average values of each group of 15 persons. Moreover, the X-ray intensity profiles are graphed at the time of obtaining the angle index values, the ratio between the scale of the ordinate axis and the scale of the abscissa axis is equal in both of the healthy subject and the bone erosion patient in this case. The ratio of the scale of the ordinate axis and the scale of the abscissa axis of each of the X-ray intensity profiles at the time of obtaining the angle of FIG. 28 is: ordinate axis (signal value [gradation])/abscissa axis (distance [mm])=80.

As shown in FIG. 44, the representative value of the angle index value is 30 degrees in case of the healthy subject, while the representative value of the patient is smaller than that of the healthy subject to be the value of about 17 degrees. Consequently, in the present embodiment, for example, 20 degrees is stored in the storage unit 32 as an evaluation reference value of the representative value of angle index values, and the bone-flesh boundary evaluating unit 374 compares a computed index (the representative value of the angle index values) with the evaluation reference value stored in the storage unit 32, and thereby evaluates the degree of the bone erosion in the bone-flesh boundary index computing region U of evaluation object bone B1.

For example, if the degree of bone erosion of a person to be imaged whose past computed indices are stored in the storage unit 32 is judged, the control unit 31 reads the past computed indices from the storage unit 32, and determines to comparatively display the computed indices and the computed indices obtained this time.

On the other hand, if the degree of bone erosion of a person to be imaged whose past computed indices are not stored in the storage unit 32 is judged, the control unit 31 reads the evaluation reference value (the evaluation reference value of the angle index value of 20 degrees in the present embodiment) from the storage unit 32, and determines to comparatively display the evaluation reference value and the computed indices obtained this time.

Incidentally, the evaluation reference value has been obtained from experiments, simulations, the analyses of past data, and the like in order to be able to judge the initial symptoms of bone erosion. Incidentally, it is assumed in this case that, when the angle to be the evaluation reference value is obtained, the angle is the one under the aspect ratio (the ratio of the scale of an ordinate axis and the scale of the abscissa axis in a graph) equal to that of the X-ray intensity profile to be plotted in the image processing apparatus 30.

[Other Bone-Flesh Boundary Indices: Frequency Analysis]

Moreover, although the above-stated example has shown the example of computing the gradient of an X-ray intensity profile to positions of a bone portion in the neighborhood of a bone-flesh boundary from the X-ray intensity profile to positions to use the computed gradient as a bone-flesh boundary index, the present invention is not limited to this example. For example, the bone-flesh boundary index may be computed by performing the frequency analysis of the data of the shape of the bone-flesh boundary.

In this case, the bone-flesh boundary index computing unit 37 recognizes the shape of a joint portion of an evaluation object bone from a phase contrast image of the evaluation object bone. When an evaluation object bone specifying instruction is input from an operator to the input unit 33, the bone-flesh boundary index computing unit 37 specifies an evaluation object bone among the bones in the phase contrast image on the basis of the content of the instruction, and recognizes the shape of a joint portion of the evaluation object bone. To put it concretely, as shown in FIG. 45A, when a phase contrast image G3 of a hand is acquired, the bone-flesh boundary index computing unit 37 determines a bone-flesh boundary index computing region R3 so that a joint portion of an evaluation object bone B4 in the image may fall into the bone-flesh boundary index computing region R3. After that, as shown in FIG. 45B, the bone-flesh boundary index computing unit 37 performs image processing to the image data in the bone-flesh boundary index computing region R3, and thereby extracts only the shape of a real joint portion. The bone-flesh boundary index computing unit 37 collates the external form line F4 of the extracted joint portion with the external form line F5 of a joint portion in the shape list in the storage unit 3, and thereby specifies which bone the evaluation object bone B4 is.

Incidentally, various methods can be considered as the method of determining the bone-flesh boundary index computing region. For example, the method of specifying a rectangular frame with the input unit 33 to determine the bone-flesh boundary index computing region, or the method of performing an image analysis of an X-ray image to automatically determine the bone-flesh boundary index computing region can be considered. If the bone-flesh boundary index computing region is automatically determined, the bone-flesh boundary index computing region must be determined so that the border of a joint portion of the evaluation object bone B4 may fall into at least the bone-flesh boundary index computing region.

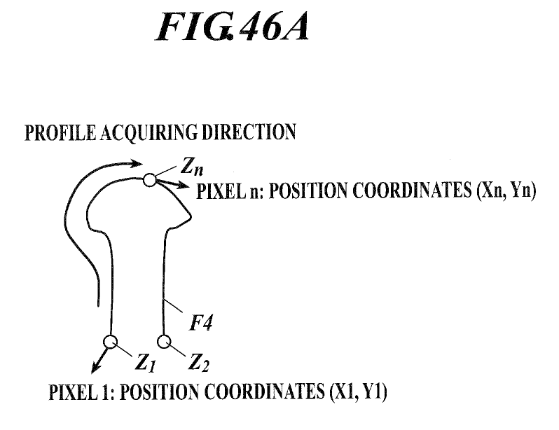

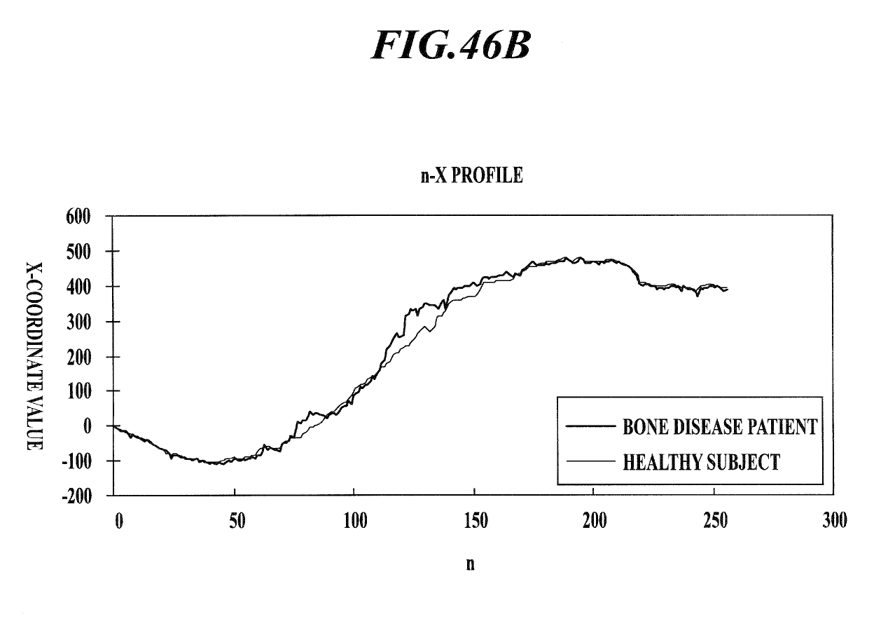

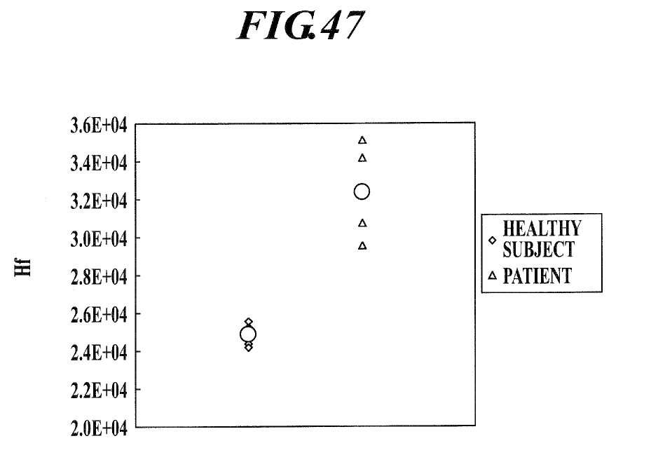

The bone-flesh boundary index computing unit 37 acquires a shape profile indicating the changes of the shape of a bone B4 from the external form line F of a bone. To put it concretely, as shown FIG. 46A, the bone-flesh boundary index computing unit 37 acquires the X-coordinate value and the Y-coordinate value of each pixel Zn on the external form line F4 every predetermined interval toward a profile acquiring direction from a pixel Z1, as a starting point, of the left side end point of the external form line F4 of the bone fell into the bone-flesh boundary index computing region R3, and ends at the right side end point Z2 of the external form line F4. Then, the bone-flesh boundary index computing unit 37 determines the X-coordinate and the Y-coordinate of the starting point (1^{st} point) as (X1, Y1), and determines the X-coordinate and the Y-coordinate of an n^{th} point as (Xn, Yn). The bone-flesh boundary index computing unit 37 produces an n-X profile using the n^{th} point as the abscissa axis and using the X-coordinate values as the ordinate axis, and an n-Y profile using the n^{th} point as the abscissa axis and using the Y-coordinate value as the ordinate axis as a shape profile. FIG. 46B shows examples of the n-X profiles of a bone disease patient and a healthy subject.

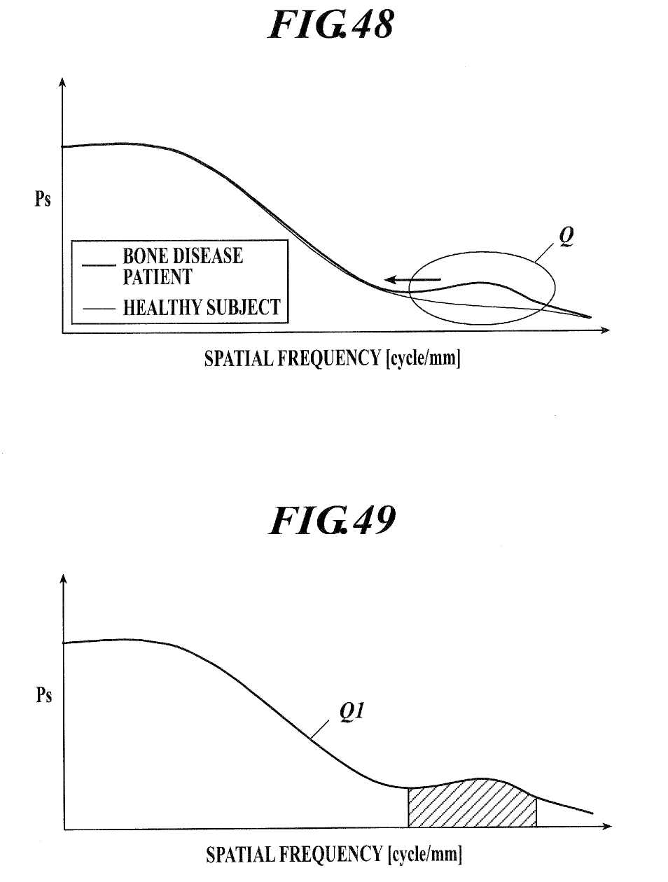

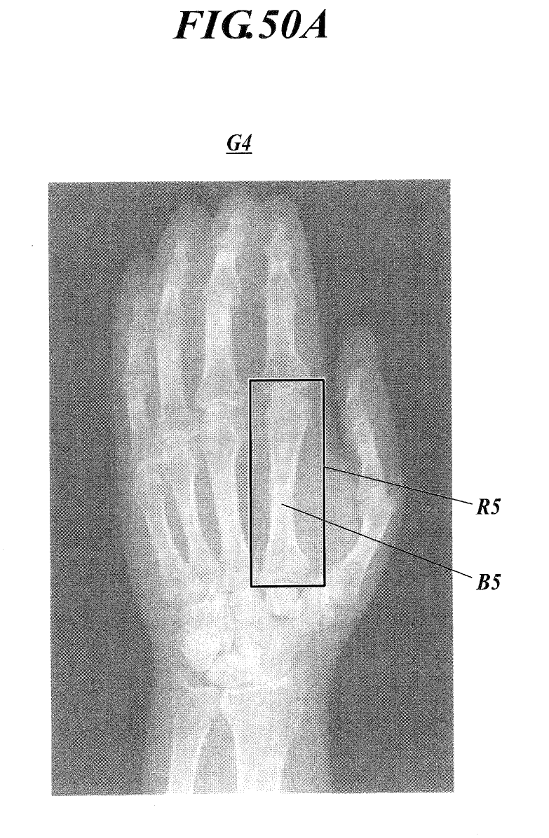

The bone-flesh boundary index computing unit 37 performs a frequency analysis to a shape profile. As the frequency analysis, for example, an analysis method by a Fourier transformation and an analysis method by a wavelet transformation can be given. FIG. 48 is a graph showing an example of the result of acquiring the shape profiles of the joint portions of both of a bone disease patient and a healthy subject to perform a Fourier transformation to the acquired shape profile. As shown in FIG. 48, the power spectrum (PS) of a bone disease patient becomes higher than that of a healthy subject in the region enclosed by an ellipse Q. As mentioned above, if a frequency analysis is performed to a shape profile of a joint portion, the differences between the healthy subject and the patient are revealed in the analysis result.

The bone-flesh boundary index computing unit 37 computes a bone-flesh boundary index on the basis of the analysis result of the frequency analysis. To put it concretely, as shown in FIG. 49, the bone-flesh boundary index computing unit 37 integrates, for example, an analysis result Q1 in a region of a spatial frequency of 5-10 cycles/mm, and computes the integration value as the bone-flesh boundary index. The region of the spatial frequency of 5-10 cycles/mm has been determined within a place (the above-mentioned ellipse Q) at which the differences between the bone disease patient and the healthy subject are easily revealed.

Then, the bone-flesh boundary index computing unit 37 compares the presently obtained computed index with the previously determined evaluation reference value in the storage unit 32, and thereby judges whether any disease of the joint portion of the bone has appeared or not.

For example, FIG. 47 shows comparison of computed indices (the above-mentioned integration values Hf) of 5 healthy subjects and 5 bone disease patients. Incidentally, the marks o in the figure indicate average values of the respective 5 persons. As shown in FIG. 47, the average value of the computed indices of the healthy subjects is about 25000, while the average value of the computed indices of the patients is about 32500. Consequently, in the present embodiment, for example, 30000 is stored in the storage unit 32 as the evaluation reference value. The bone-flesh boundary index computing unit 37 compares the presently computed index with the evaluation value stored in the storage unit 32 in advance, and thereby the bone-flesh boundary index computing section 87 evaluates the existence of any disease in the bone-flesh boundary index computing region R3 of the evaluation object bone B4.

[Other Bone-Flesh Boundary Indices: Signal Intensity]

Moreover, although in the above-stated example, the example of performing the frequency analysis of the data of the shape of a bone-flesh boundary to obtain the bone-flesh boundary indices has been shown, but the present invention is not limited to this example. For example, a bone-flesh boundary index computing region including a bone portion in the neighborhood of a bone-flesh boundary of a subject may be determined, and the bone-flesh boundary indices may be computed on the basis of the information corresponding to the maximum X-ray intensity of the image data in the bone-flesh boundary index computing region.

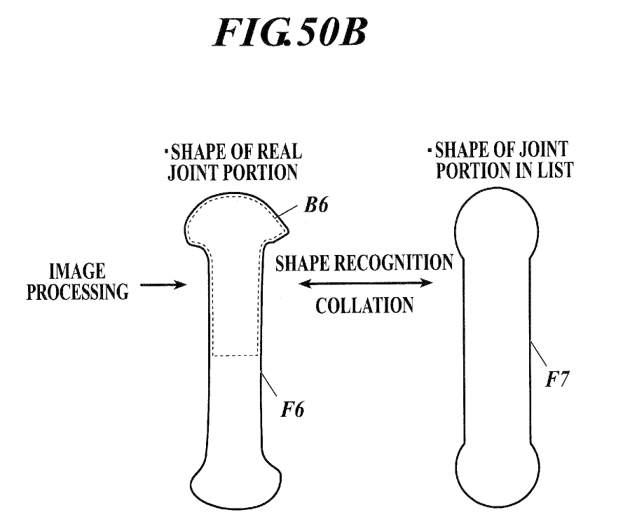

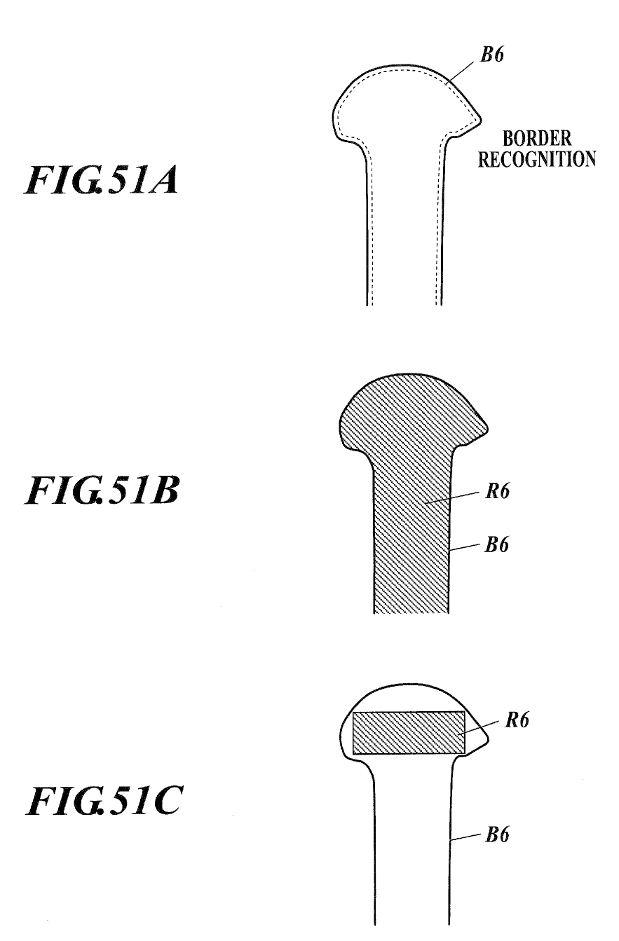

In this case, when an operator inputs an evaluation object bone specifying instruction into the input unit 33, the bone-flesh boundary index computing unit 37 specifies an evaluation object bone among the respective bones in a phase contrast image on the basis of the content of the instruction, and recognizes the shape and the joint portion of the specified evaluation object bone. To put it concretely, as shown in FIG. 50A, when a phase contrast image G4 of a hand is acquired, the bone-flesh boundary index computing unit 37 determines a joint portion recognizing region R5 so that the whole body of an evaluation object bone B5 in the image may fall into the joint portion recognizing region R5. After that, as shown in FIG. 50B, the bone-flesh boundary index computing unit 37 performs image processing to the image data in the joint portion recognizing region R5, and thereby extracts only the shape of a real joint portion. In the shape extraction of the joint portion, for example, the bone-flesh boundary index computing unit 37 discriminates the bone portion from the flesh portion from the X-ray intensity profile to follow the border of the evaluation object bone B5, and thereby recognize the shape of the evaluation object bone B5. After that, the bone-flesh boundary index computing unit 37 collates the external form line F6 of the extracted joint portion with the external form line F7 of the joint portion in the shape list in the storage unit 32, and thereby specifies which the evaluation object bone B5 is. Then the bone-flesh boundary index computing unit 37 recognizes the joint portion B6.

The bone-flesh boundary index computing unit 37 determines the bone-flesh boundary index computing region composed of the joint portion B6. To put it concretely, as shown in FIG. 51A, the bone-flesh boundary index computing unit 37 recognizes the border of the joint portion B6, and determines the bone-flesh boundary index computing region so that the bone portion in the inner part of the border may be the bone-flesh boundary index computing region, that is, not so as to include any flesh portions. Although various methods of determining the bone-flesh boundary index computing region can be considered, for example, as shown in FIG. 51B, the whole body of the joint portion B2 may be determined as the bone-flesh boundary index computing region R6, or as shown in FIG. 51C, only a part of the joint portion B2 may be determined as the bone-flesh boundary index computing region R6. In the former case, the area of the bone-flesh boundary index computing region R6 is large, and consequently the bone-flesh boundary index can be computed with high accuracy. In the latter case, if the area of the bone-flesh boundary index computing region R6 is determined to be fixed in each patient, the dispersion among patients can be standardized.

The bone-flesh boundary index computing unit 37 detects the X-ray signal intensity of each pixel in the bone-flesh boundary index computing region R6, and detects the X-ray signal intensity of each pixel in the phase contrast image G4. The bone-flesh boundary index computing unit 37 acquires the maximum value (the information corresponding to the maximum X-ray intensity) among the X-ray signals of the respective pixels in the bone-flesh boundary index computing region R6, and acquires the maximum value of the X-ray signal intensities of the respective pixels in the phase contrast image G4.

The bone-flesh boundary index computing unit 37 computes the bone-flesh boundary indices on the basis of the maximum value in the bone-flesh boundary index computing region R6. To put it concretely, if the maximum value of the X-ray signal intensities corresponding to the maximum X-ray intensity in the bone-flesh boundary index computing region R6 is determined as Srmax, and if the maximum value of the X-ray signal intensities corresponding to the maximum X-ray intensity in the phase contrast image G4 is determined as Simax, then the bone-flesh boundary index computing unit 37 computes the ratio of Srmax to Simax as a bone-flesh boundary index. Incidentally, although the above-mentioned ratio is exemplified to be Srmax/Simax to be described in the present embodiment, Simax/Srmax may be determined as the above-mentioned ratio.

Then, the bone-flesh boundary index computing unit 37 compares the presently obtained computed index with the previously determined evaluation reference value in the storage unit 32, and thereby judges whether any disease appears in the joint portion of the bone or not.

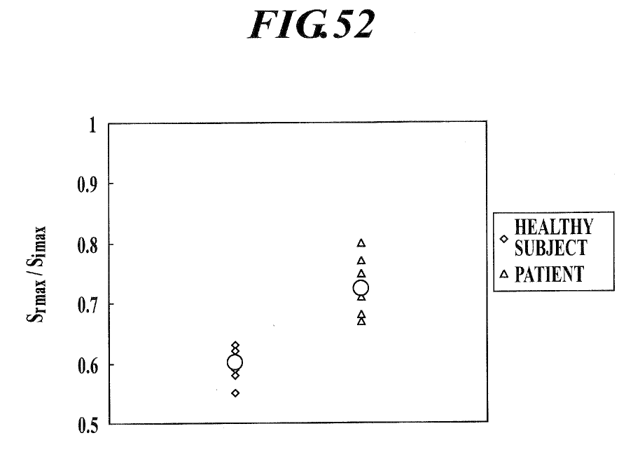

For example, FIG. 52 shows comparison of the computed indices (the above-mentioned Srmax/Simax) between 5 healthy subjects and 5 bone disease patients. Incidentally, in the figure, each of the marks o indicates an average value of 5 persons. As shown in FIG. 52, the average value of the computed indices of the healthy subjects is about 0.6, while the average value of the computed indices of the patients is about 0.7. Consequently, in the present embodiment, for example, 0.65 is stored in the storage unit 32 as the evaluation reference value, and the bone-flesh boundary index computing unit 37 compares the presently computed computed index with the evaluation reference value previously stored in the storage unit 32, and thereby evaluates the existence of any disease in the bone-flesh boundary index computing region R6 of the evaluation object bone B5.

As the bone-flesh boundary indices other than the above-mentioned indices, for example, when the maximum value of the X-ray signal intensities corresponding to the maximum X-ray intensity in the bone-flesh boundary index computing region R6 is denoted by Srmax, and the minimum value of the X-ray signal intensities corresponding to the minimum X-ray intensity in the bone-flesh boundary index computing region R6 is denoted by Srmin, then an index expressed by the ratio of the Srmax to the Srmin can be given. Incidentally, although a description will be given by exemplifying Srmax/Srmin as the aforesaid ratio in the present embodiment, Srmin/Srmax may be determined as the aforesaid ratio.

In this case, the bone-flesh boundary index computing unit 37 acquires the minimum value among the X-ray signal intensities of the respective pixels in the bone-flesh boundary index computing region R6, and when the maximum value among the X-ray signal intensities in the bone-flesh boundary index computing region R6 is denoted by Srmax, and the minimum value among the X-ray signal intensities in the bone-flesh boundary index computing region R6 is denoted by Srmin, then the bone-flesh boundary index computing unit 37 determines Srmax/Srmin as the bone-flesh boundary index.

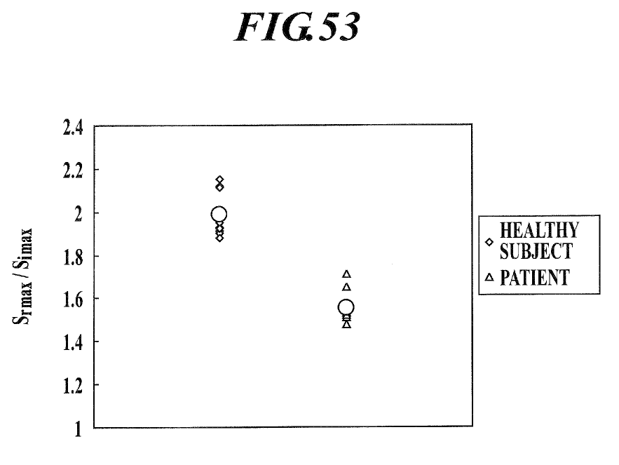

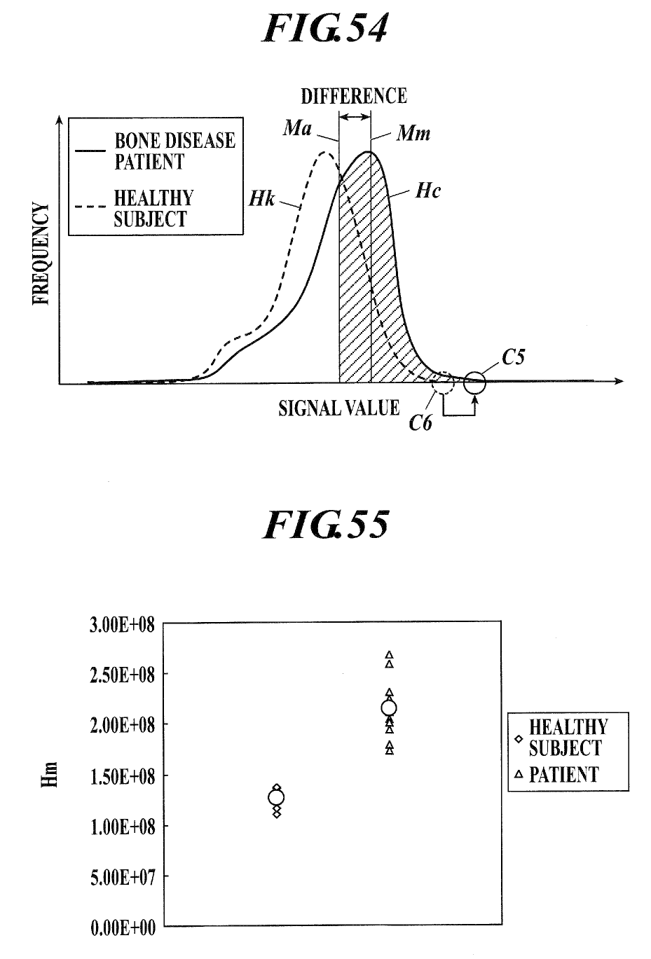

For example, FIG. 53 shows the comparison of computed indices (the aforesaid Srmax/Srmin) between 5 healthy subjects and 5 bone disease patients. Incidentally, in the figure, each of the marks o indicates the average value of 5 persons. As shown in FIG. 53, the average value of heft computed indices of the healthy subjects is about 2.0, while the average value of the computed indices of the patients is about 1.5. Consequently, in this case, for example, 1.8 is stored in the storage unit 32 as the evaluation reference value, and the bone-flesh boundary index computing unit 37 compares the presently computed computed index with the evaluation reference value previously stored in the storage unit 32 to evaluate the existence of any disease in the bone-flesh boundary index computing region R6 of the evaluation object bone B5.

Moreover, as a bone-flesh boundary index other than the above-mentioned indices, for example, an index expressed by an integration value obtained by producing a histogram of each X-ray signal intensity from the X-ray signal intensity of each pixel in the bone-flesh boundary index computing region R6, and by integrating the histogram from the center value of the histogram to the maximum value of the X-ray signal intensities in the bone-flesh boundary index computing region R6 can be given.

FIG. 54 is a histogram produced on the basis of the X-ray signal intensities of the respective pixels in the bone-flesh boundary index computing region R6 composed of the joint portion B6, and shows the comparison of the histograms between the bone disease patient and the healthy subject. If the histogram Hc of the bone disease patient and the histogram Hk of the healthy subject are compared with each other, the histogram Hc more decreases on the lower signal value side and more increases on the higher signal value side in comparison with the histogram Hk. Then, the maximum signal value (see circles C5 and C6 in the figure) of the histogram Hc becomes higher than that of the histogram Hk. This is because the trabecula parts decrease and then the entire signal value shifts to the higher signal value side. The integration value of the histogram Hc (shaded area) higher than the center signal value of the bone disease patient becomes higher than that of the histogram Hk.

To put it concretely, for example, FIG. 55 shows the comparison between the computed indices (the aforesaid integration value Hm) of 5 healthy subjects and 5 bone disease patients. Incidentally, each of the marks o in the figure denotes an average value of 5 persons. As shown in FIG. 55, the average value of the computed indices of the healthy subjects is about 1.27×108, while the average value of the computed indices of the patient is about 2.14×108. Consequently, in this case, for example, 1.7×108 is stored in the storage unit 32 as the evaluation reference value, and the bone-flesh boundary index computing unit 37 compares the presently computed index with the evaluation reference value previously stored in the storage unit 32 to evaluate the existence of any disease in the bone-flesh boundary index computing region R6 of the evaluation object bone B5.

Furthermore, as a bone-flesh boundary index other than the aforesaid indices, for example, an index obtained by producing a histogram of each X-ray signal intensity from the X-ray signal intensity of each pixel in the bone-flesh boundary index computing region R6 and by operation the subtraction of the X-ray signal intensity value that is the maximum frequency of the histogram from the center value of the histogram can be given.

Here, as described above, if the histogram Hc of the bone disease patient and the histogram Hk of the healthy subject are compared with each other in FIG. 54, then the histogram Hc more decreases on the lower signal value side and more increases on the higher signal value side than those of the histogram Hk, but the lowest signal value of histogram Hc does not almost change and the difference between the center value (Ma) and the X-ray signal intensity value (Mm) indicating the maximum frequency becomes larger.

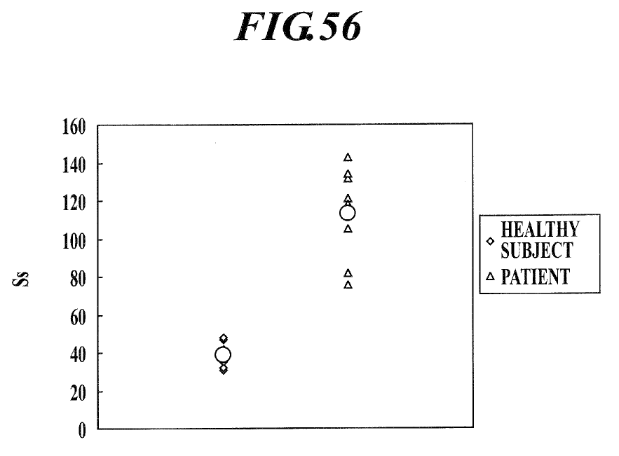

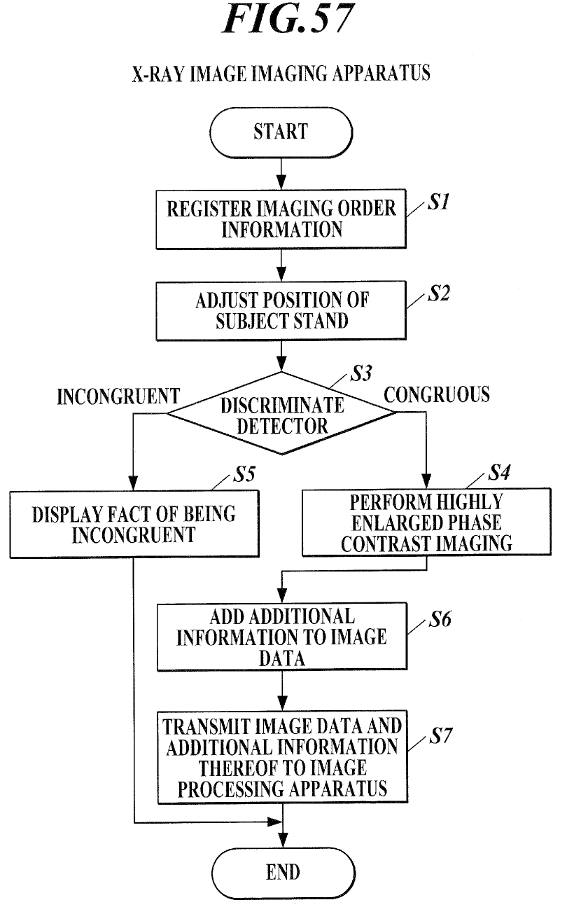

To put it concretely, for example, FIG. 56 shows the comparison between the computed indices (the aforesaid difference value Ss) of 5 healthy subjects and 5 bone disease patients. Incidentally, each of the marks o in the figure indicates the average value of the 5 persons. As shown in FIG. 56, the average value of the computed indices of the healthy subjects is about 39.0, while the average value of the computed indices of the patients is about 113.4. Consequently, in this case, for example, 75 is stored in the storage unit 32 as the evaluation reference value, and the bone-flesh boundary index computing unit 37 compares the presently computed index with the evaluation reference value previously stored in the storage unit 32 to evaluate the existence of any disease in the bone-flesh boundary index computing region RE of the evaluation object bone B5.

[Other Controls]

Then, on the basis of the above-stated determination result, the control unit 31 makes a display unit of the image output apparatus 50, which will be described later, display according to determination result, or makes film output according to the determination result.

[Image Processing Unit]

The image processing unit 35 performs image processing to the image data of an X-ray image, such as gradation processing for adjusting the contrast of the image, processing for adjusting a density, frequency processing for adjusting sharpness, and the like. Hereby, it is possible to perform image processing fitted to the conditions such as an imaging region.

Incidentally, it is preferable to previously store image processing parameters defining image processing conditions corresponding to the conditions such as an imaging region, an imaging condition, and imaging direction into the storage unit 32 or the like. At the time of performing image processing, it is preferable that the image processing unit 35 reads from the storage unit 32 the image processing parameters corresponding to the information added to image data, such as which region of a body an X-ray image images, the imaged region, and imaging direction, according to the information, and to determine the image processing condition on the basis of the read parameter. Incidentally, if the information, such as the imaged region and imaging direction is not added to image data, then a necessary condition may be input from the input unit 33 or the like, and image processing may be performed on the input condition.

[Image Output Apparatus]

Next, the image output apparatus 50 is, for example, an image display apparatus or a printer, which is composed of an output unit, such as a monitor, such as a cathode ray tube (CRT) or a liquid crystal display (LCD), or a printing unit for printing (film outputting) image data on a medium, such as a film or a sheet of paper, a communication unit for the connection to external equipment, and a power source unit (any of them are not shown) for supplying electric power. The image output apparatus 50 functions as output section for outputting a judgment result by the control unit 31 when the control unit 31 performs the judgment of the existence of changed parts (changed regions) as for whether there are any changes in each of the parts between an object image and a past image or not. The communication unit is composed of a network interface and the like, and performs the transmission and the reception of data with external equipment, such as the X-ray image imaging apparatus 1 and the image output apparatus 50, which is connected to the network N through the switching hub.

When the communication unit 34 receives the image data of an X-ray image, which image data has been subjected to image processing by the image processing apparatus 30, through the network N, the image output apparatus 50 suitably outputs the image with the output unit (display unit or printing unit).

Moreover, as described above, if the image processing apparatus 30 had determined display content, then, for example, the determination of the display content is displayed on the display unit of the image output apparatus 50, or the determination of the display content is clearly shown on a film output.

Incidentally, if the image output apparatus 50 is an image display apparatus equipped with a monitor, then it is preferable that the image output apparatus 50 is provided with a high-definition monitor than that of equipped in a general personal computer (PC) or the like because the image output apparatus 50 is for the purpose of displaying a medical image for a diagnosis so that a doctor or the like can perform a diagnosis.

[X-Ray Image Analysis Program and X-Ray Image Processing Method]

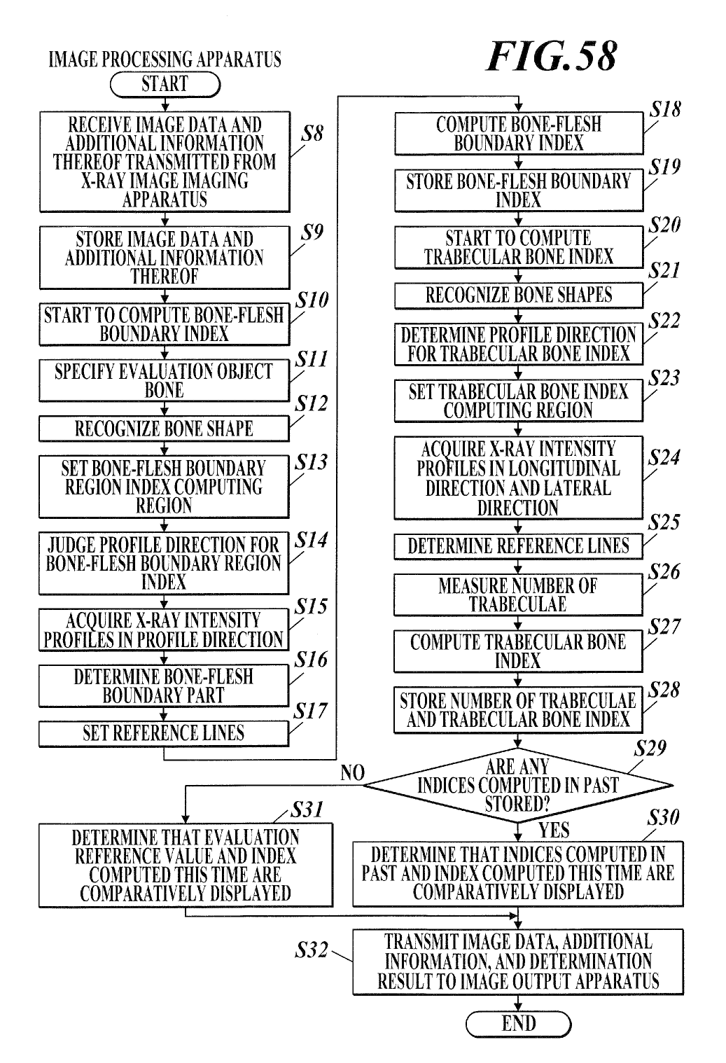

Next, an X-ray image analysis program and an X-ray image processing method, which will be executed in the X-ray image analyzing system 100 in the present embodiment, will be described with reference to FIGS. 57-59.

First, at Step S1 of FIG. 57, when imaging order information is registered by an examination registration (imaging order registration) of a person to be imaged (patient) with a not shown examination acceptance or the like, the person to be imaged places either of the left and right arm portions on the subject stand 14 on the basis of the imaging order information, and the triangular magnet 17 is placed so as to be contacted with both the thumb and the forefinger of the hand.

After that, the drive apparatus 6 and the position adjusting apparatus 15 performs the adjustment of the position of the subject stand 14 and the adjustment of the angle of the imaging apparatus main body unit 4 in accordance with the imaging conditions, such as an X-ray radiating angle, a radiation distance, and an imaging magnification ratio. In the present embodiment, the position of the subject stand 14 is adjusted so that the phase contrast simple X-ray imaging may be performed (Step S2).

Then, at Step S3, if the X-ray detector 11 identified by the X-ray detector identifying unit 29 does not agree with the congruous X-ray detector determined at Step S2, that is, the X-ray detector 11 is congruent, then the control apparatus 22 moves the processing to that at Step S4. If the X-ray detector 11 is identified as that for the phase contrast imaging, then the control apparatus 22 moves the processing to that at Step S5.

At Step S4, the control apparatus 22 controls the display apparatus 24b to display that the set X-ray detector 11 is incongruent with the present imaging, and ends the present processing.

At Step S5, after the adjustment of the position and the angle of the subject stand 14, the power source unit 9 applies a tube voltage to the X-ray source 8 so that average radiate energy may be 26 keV. The X-ray source 8 radiates an X-ray toward the subject H to perform phase contrast simple X-ray imaging.

When the image data of an phase contrast image is generated, imaging direction information, left and right information, the information of the person to be imaged, imaging time information, region information, and the like are added to each generated image data as additional information (Step S6). Then, the X-ray image imaging apparatus 1 transmits the image data of the generated X-ray image to the image processing apparatus 30 together with the additional information (Step S7).

As shown at Step S8 of FIG. 53, when the image processing apparatus 30 receives the image data and the additional information thereof from the X-ray image imaging apparatus 1, the image processing apparatus 30 saves (stores) the received image data and the additional information thereof into the storage unit 32 (Step S9).

After that, the control unit 31 controls the bone-flesh boundary index computing unit 37 to start the computation of bone-flesh boundary indices (Step S10).

After the computation of the bone-flesh boundary indices, the control unit 31 first specifies the bone specified by the input unit 33 as the evaluation object bone B1 (Step S11).

After that, the control unit 31 controls the bone-flesh boundary index computing region determining (setting) unit 371 to recognize the shape of the evaluation object bone B3 in the image data (Step S12). The control unit 31 compares the shape of the evaluation object bone B3 with the shape list in the storage unit 32, and thereby specifies the shape and the direction of the evaluation object bone B3. The control unit 31 determines the bone-flesh boundary index computing region U (Step S13).

Then, the control unit 31 controls the direction recognizing section for bone-flesh boundary 372 to judge the profile direction in the bone-flesh boundary index computing region U (Step S14).

After the determination of the profile direction, the control unit 31 controls the profile acquiring section for bone-flesh boundary 373 to acquire a plurality of X-ray intensity profiles at predetermined intervals in the profile direction in the bone-flesh boundary index computing region U (Step S15).

After the acquisition of the X-ray intensity profiles, the control unit 31 controls the bone-flesh boundary determining unit 375 to determine a bone-flesh boundary part in each of the X-ray intensity profiles (Step S16).

After that, the control unit 31 controls the bone-flesh boundary evaluating unit 374 to determine the reference lines a, b, and c in the X-ray intensity profile (Step S17).

The control unit 31 controls the bone-flesh boundary evaluating unit 374 to compute bone-flesh boundary indices (a representative value of the angle index values of the X-ray intensity profile in the bone-flesh boundary part) (Step S18).

The control unit 31 controls the storage unit 32 to store the bone-flesh boundary indices (Step S19).

Successively, the control unit 31 controls the trabecular bone index computing unit 36 to start the computation of the trabecular bone indices (Step S20).

After the starting of the computation of the trabecular bone indices, the control unit 31 first controls the direction recognizing unit for trabecular bone 362 to recognize the shape of each bone in the image data (Step S21).

Then, the control unit 31 specifies the radial bone B1 from each bone in the image data on the basis of the shape of each recognized bone and the shape list in the storage unit 32, and determines the profile directions (length and breadth directions) for trabecular bone indices in the radial bone B1 (Step S22).

After the determination of the length and breadth directions, the control unit 31 controls the trabecular bone index computing region determining unit 361 to determine the trabecular bone index computing region R based on the length and breadth directions (Step S23).

After the completion of the determination of the trabecular bone index computing region R, the control unit 31 controls the profile acquiring unit for trabecular bone 363 to acquire a plurality of X-ray intensity profiles at predetermined intervals in the longitudinal direction and the lateral direction in the trabecular bone index computing region R (Step S24).

After the acquisition of the plurality of X-ray intensity profiles in the longitudinal direction and the lateral direction, the control unit 31 controls the trabecular bone evaluating unit 364 to determine the reference line J of each line (Step S25).

Then, the trabecular bone evaluating unit 364 measures the trabecular image number of each line of the X-ray intensity profiles in the longitudinal direction and the lateral direction (Step S26).

After that, the trabecular bone evaluating unit 364 averages the trabecular image numbers of the respective lines, and computes the representative values in the longitudinal direction and the lateral direction as the trabecular bone indices (Step S27).

The control unit 31 controls the storage unit 32 to store the measured trabecular image numbers and the trabecular bone indices (Step S28).

Then, the control unit 31 judges whether the past computed indices (bone-flesh boundary indices and trabecular bone indices) of the person to be imaged are stored in the storage unit 32 or not on the basis of the information of the person to be imaged added to the image data (Step S29). If the computed indices of the subject are stored (Step S29: YES), then the control unit 31 moves the present processing to that at Step S30. If the computed indices are not stored (Step S29: NO), then the control unit 31 moves the present processing to that at Step S31.

At Step S30, the control unit 31 reads the past computed indices of the person to be imaged, who is the examination object, from the storage unit 32, and determines to comparatively display the computed indices and the computed indices obtained this time. Then, the control unit 31 moves the present processing to that at Step S32.

At Step S31, the control unit 31 reads the evaluation reference value from the storage unit 32, and determines to comparatively display the evaluation reference value and the computed indices obtained this time. Then, the control unit 31 moves the present processing to that at Step S32.

Then, at Step S32, the control unit 31 transmits the image data transmitted from the X-ray image imaging apparatus 1, the additional information, the present computed indices, the evaluation reference value, the determination results, and, if any, the past computed indices to the image output apparatus 50 through the communication unit 34.

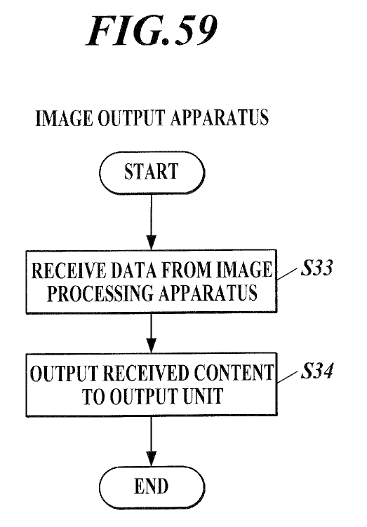

As shown at Step S33 in FIG. 59, when the image output apparatus 50 receives data from the image processing apparatus 30, the image output apparatus 50 makes the output unit output the received content (Step S34). As described above, as the output method, either of the viewer display by a monitor (display unit) and the film output (hard copy) by a printing unit may be adopted. Hereby, the image output apparatus 50 enables the perusal of image data, the additional information thereof, present computed indices, an evaluation reference value, comparative display based on a determination result, and past computed indices. Here, the image output apparatus 50 enables the comparative display of the present computed indices and past computed indices, and the comparative display of the present computed indices and the evaluation reference value.

Incidentally, although the present embodiment is configured to execute only the processing at Step S30 if the past computed indices of the subject are stored at Step S29, the processing at Step S31 may be executed in parallel with the processing at Step S30.

As described above, according to the X-ray image analyzing system 100 in the present embodiment, an X-ray image having a sufficient phase effect by X-ray refraction on a subject and a clear boundary including an X-ray refractive index difference can be acquired, when phase contrast simple X-ray imaging is executed, by determining an X-ray average energy of the X-ray at the time of the imaging to be 32 KeV or less, by determining the diameter of an focused X-ray beam of an X-ray source radiating the X-ray to be 150 μm or less, by determining a distance from the subject to the X-ray image detection surface to be 0.2 m or more, by determining the ratio M of a distance from the subject to the X-ray image detection surface to the subject to a distance from the X-ray source to the subject to be 1.5 or more, and by determining a detection interval between pixels of detection pixels arranged on the X-ray image detection surface to be 100×M (μm) or less. Because the X-ray image also has an expansion imaging effect including little blurring, minute structures of the subject are delineated, and optimum absorption contrast is also given to the subject owing to a low energy X-ray imaging effect. By the multiplier effect of these effects, the phase contrast simple X-ray imaging satisfying the above-mentioned conditions would be able to acquire an X-ray image from which trabecular bone indices and bone-flesh boundary indices can be computed. That is, the appropriate trabecular bone indices and the bone-flesh boundary indices can be computed from the same X-ray image of the subject of a hand, and it becomes possible to perform early diagnoses of arthropathy and osteoporosis.

Moreover, although the example of computing the bone-flesh boundary indices before computing the trabecular bone indices has been shown in the above-stated flow, the order of the computation of the plurality of indices has not especial restrictions, and any order may be adopted. Moreover, the computations may be performed at the same time.

Moreover, because the trabecular image number in the longitudinal direction and the trabecular image number in the lateral direction are measured on the basis of each of the X-ray intensity profiles in the longitudinal direction and the X-ray intensity profiles in the lateral direction, and because the relation between the length and breadth directions of the trabecular image number is obtained on the basis of the measurement results, a quantitative diagnosis suppressing the influences of individual differences can be realized with high accuracy.

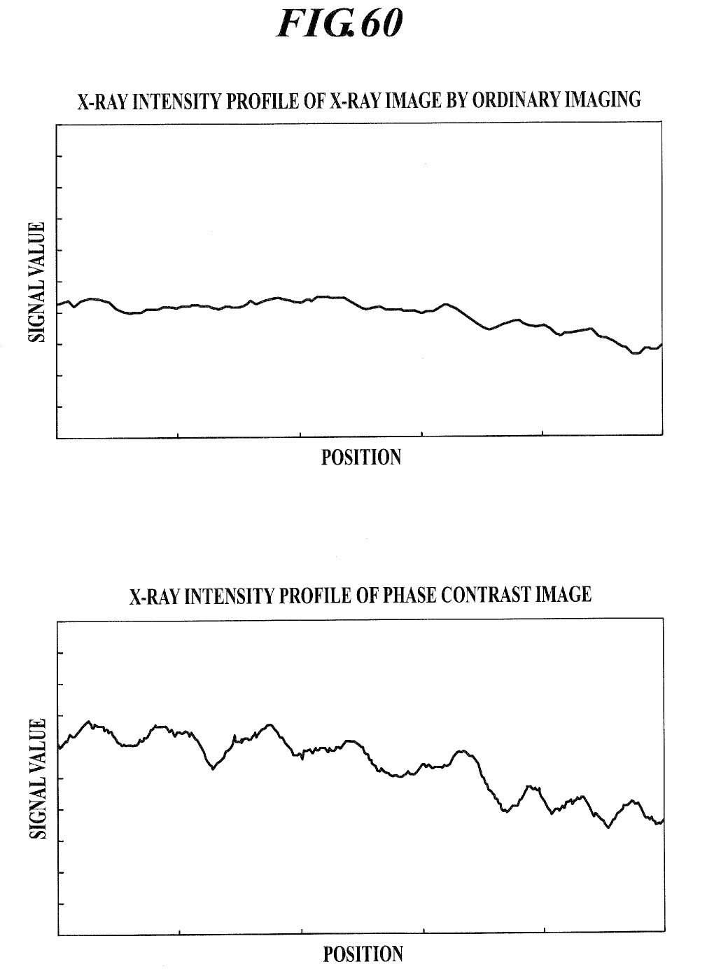

Moreover, the present embodiment obtains the X-ray intensity profiles on the basis of a phase contrast image. The reason is because the differences of X-ray signal intensities of the phase contrast image are clearer in comparison with the X-ray image by ordinary imaging, and because the trabecular image number can be measured with high accuracy (see, for example, FIG. 60. As shown in FIG. 60, although the X-ray signal intensity in the X-ray image by the ordinary imaging is not easily changes, the X-ray signal intensity of the X-ray image by the phase contrast imaging easily changes, and the trabeculae thereof can be easily specified).

Then, according to the X-ray image analyzing system 100 in the present embodiment, the degree of the progress of bone erosion can be diagnosed quantitatively by computing the angle index value indicating the angle formed by an X-ray intensity profile of the bone-flesh boundary part. Thereby, the quantitative diagnosis accuracy of bone erosion can be more heightened in comparison with the prior art.

Moreover, because a subject is a hand in the present embodiment, the radial bone B1 in which the symptoms of the osteoporosis easily appear can be easily placed within a phase contrast image. The trabeculae of a thighbone and a backbone can be easily viewed, but the exposure doses of the subjects of the thighbone and the backbone become much, and the imaging of them are not easy. The imaging of a hand is simple, and the exposure dose thereof is little. Furthermore, because the symptoms of a bone disease appear at the ends of a body, the use of a hand bone image makes it possible to discover a bone disease earlier than the case of using the thighbone or the backbone.

Then, because the image output apparatus 50 comparatively displays the past evaluation results stored in the storage unit 32 and the evaluation result presently obtained by the trabecular bone evaluating unit 364 in the present embodiment, the past symptoms and the present symptoms can be compared easily, and more efficient diagnosis is enabled.

Furthermore, because the image output apparatus 50 comparatively displays the evaluation reference value stored in the storage unit 32 and an evaluation result presently obtained by the trabecular bone evaluating unit 364 in the present embodiment, the evaluation reference value and the present symptoms can be easily compared, and more effective diagnosis is enabled.

Incidentally, although the case of proving the image processing apparatus 30 and the image output apparatus 50 are separated apparatus has been described as an example in the present embodiment, the configuration of providing image processing section, storage section, judgment section, and display section or printing section as the output section in an apparatus, and sharing the image processing apparatus 30 and the image output apparatus 50 as an apparatus may be adopted.

Moreover, although the case of judging the degree of the progress of osteoporosis only by the trabecular image number has been exemplified in the above embodiment, more various evaluations can be performed by considering the depth of a trabecular image, the distance between trabecular images, and the width of a trabecular image. For example, osteoporosis includes two types of a high bone turnover type and a low bone turnover type. The high bone turnover type osteoporosis has the features that the trabeculae in the longitudinal direction can easily remain because the formation of the bone is urged by external stimuli, and that the trabeculae in the lateral direction easily decrease. On the other hand, because the bone formation of the low bone turnover type osteoporosis dose not easily proceed, both of the longitudinal trabeculae and the lateral trabeculae greatly decrease. Furthermore, the low bone turnover type osteoporosis has the feature of the remarkable shallowing of the depth of a trabecular image. Although the automatic evaluation of the type of the osteoporosis has been difficult by the prior art, the judgment by the type becomes possible as described above by considering the trabecular image number, the depth of a trabecular image, and the width of a trabecular image.

To put it concretely, after the determination of a reference line, the trabecular bone evaluating unit 364 of the image processing apparatus 30 measures not only the trabecular image number in each of the longitudinal direction and the lateral direction, but also measures the depth of a trabecular image and the width of a trabecular image on the basis of the X-ray intensity profiles in the longitudinal direction and the lateral direction, and computes the aspect ratio of each representative value as a computed index. After that, if the aspect ratio of the trabecular image number is the evaluation reference value or less, the trabecular bone evaluating unit 364 judges that the possibility of the high bone turnover type osteoporosis is high. On the other hand, if the aspect ratio of the trabecular image number is larger than the evaluation reference value, the trabecular bone evaluating unit 364 judges whether the representative value of the depth of a trabecular image or the representative value of the width of a trabecular image is smaller than a predetermined value or not. If the representative vale of the depth of a trabecular image or the representative value of the width of a trabecular image is the predetermined value or more, the trabecular bone evaluating unit 364 judges that the possibility of a healthy subject is high. Moreover, the representative value of the depth of a trabecular image or the representative value of the width of a trabecular image is smaller than the predetermined value, the trabecular bone evaluating unit 364 judges that the possibility of the low bone turnover type osteoporosis is high.

### INDUSTRIAL APPLICABILITY

The present invention can be used in the field of radiation image imaging (especially medical field).

1. An X-ray image analyzing system, comprising:
an X-ray imaging apparatus to enable phase contrast X-ray simple imaging, including:
an X-ray source for radiating an X-ray; and
an X-ray detector, having an X-ray image detection surface, for detecting an X-ray image radiated onto the X-ray image detection surface, wherein
the phase contrast X-ray simple imaging is performed under conditions that the X-ray source radiates an X-ray having an X-ray average energy of 32 Key or less and a diameter of an focused X-ray beam of 150 μm or less, a distance from a subject to the X-ray image detection surface is 0.2 m or more, a ratio M of a distance from the X-ray source to the X-ray image detection surface to a distance from the X-ray source to the subject is 1.5 or more, and a detection interval between pixels on the X-ray image detection surface is 100×M (μm) or less, and
an image processing apparatus for, from the x-ray image obtained by the phase contrast X-ray simple imaging based on a first region determination method, determining a trabecular bone index computing region, computing a trabecular bone index indicating a state of a trabecula from image data in the trabecular bone index computing region, determining a bone-flesh boundary index computing region by a second region determination method different from the first region determination method, and computing a bone-flesh boundary index indicating smoothness of a bone-flesh boundary from image data in the bone-flesh boundary index computing region.

2. The X-ray image analyzing system according to claim 1, wherein the image processing apparatus acquires an X-ray intensity profile to positions from the image data in the trabecular bone index computing region, and analyzes the X-ray intensity profile to compute the trabecular bone index.

3. The X-ray image analyzing system according to claim 2, wherein the image processing apparatus acquires the X-ray intensity profile to the positions in each direction of two or more intersecting directions from the image data in the trabecular bone index computing region, and analyzes the X-ray intensity profile to compute the trabecular bone index.

4. The X-ray image analyzing system according to claim 3, wherein the image processing apparatus performs the analysis in each of the two or more intersecting directions and compares each analysis result to compute the trabecular bone index.

5. The X-ray image analyzing system according to claim 2, wherein the image processing apparatus obtains a trabecular image number pertaining to the number of trabecular images within a predetermined range at a time of analyzing the X-ray intensity profile.

6. The X-ray image analyzing system according to claim 2, wherein the image processing apparatus obtains a trabecular image interval pertaining to an interval of the trabecular images within the predetermined range at the time of analyzing the X-ray intensity profile.

7. The X-ray image analyzing system according to claim 2, wherein the image processing apparatus uses frequency analysis at the time of analyzing the X-ray intensity profile.

8. The X-ray image analyzing system according to claim 1, wherein
the bone-flesh boundary index computing region includes a bone portion in a neighborhood of a bone-flesh boundary in the subject, and
the image processing apparatus analyzes the X-ray intensity profile at a position of the bone portion in the neighborhood of the bone-flesh boundary to compute the bone-flesh boundary index.

9. The X-ray image analyzing system according to claim 1, wherein
the bone-flesh boundary index computing region includes the bone-flesh boundary in the subject to an extent of able to analyze a shape, and
the image processing apparatus acquires bone-flesh boundary shape data indicating the shape of the bone-flesh boundary from the image data in the bone-flesh boundary index computing region, and analyzes the bone-flesh boundary shape data to compute the bone-flesh boundary index.

10. The X-ray image analyzing system according to claim 9, wherein the image processing apparatus uses the frequency analysis at a time of analyzing the bone-flesh boundary shape data.

11. The X-ray image analyzing system according to claim 1, wherein
the bone-flesh boundary index computing region includes the bone portion in the neighborhood of the bone-flesh boundary in the subject, and
the image processing apparatus computes the bone-flesh boundary index based on information corresponding to maximum X-ray intensity of the image data in the bone-flesh boundary index computing region.

12. The x-ray image analyzing system according to claim 1, wherein the X-ray imaging apparatus is arranged between the X-ray source and the X-ray detector, the X-ray imaging apparatus including a subject stand supporting the subject so that the ratio M of the distance from the X-ray source to the X-ray image detection surface to the distance from the X-ray source to the subject is 1.5 or more.

13. The X-ray image analyzing system according to claim 12, wherein the subject stand supports a hand.

14. The X-ray image analyzing system according to claim 1, wherein the X-ray image is that of the subject of the hand or a foot.

15. A program stored in a storage medium to be performed by a computer for performing operation processing from operation source image data output from an X-ray detector of an X-ray imaging apparatus including an X-ray source and the X-ray detector, comprising the steps of:
determining a trabecular bone index computing region from an X-ray image obtained by phase contrast X-ray simple imaging based on a first region determination method;
computing a trabecular bone index indicating a state of a trabecula from image data in the trabecular bone index computing region;
determining a bone-flesh boundary index computing region by a second region determination method different from the first region determination method; and
computing a bone-flesh boundary index indicating smoothness of a bone-flesh boundary from image data in the bone-flesh boundary index computing region, wherein
the X-ray imaging apparatus to enable the phase contrast X-ray simple imaging, including:
an X-ray source for radiating an X-ray; and
the X-ray detector, having an X-ray image detection surface, for detecting an X-ray image radiated onto the X-ray image detection surface, wherein
the phase contrast X-ray simple imaging is performed under conditions that the X-ray source radiates an X-ray having an x-ray average energy of 32 KeV or less and a diameter of an focused X-ray beam of 150 μm or less, a distance from a subject to the X-ray image detection surface is 0.2 m or more, a ratio M of a distance from the X-ray source to the X-ray image detection surface to a distance of the X-ray source to the subject is 1.5 or more, and a detection interval between pixels on the X-ray image detection surface is 100×M (μm) or less.

16. The program according to claim 15, wherein the program makes the computer acquire an X-ray intensity profile to positions from the image data in the trabecular bone index computing region, and analyze the X-ray intensity profile to compute the trabecular bone index.

17. The program according to claim 16, wherein the program makes the computer acquire the X-ray intensity profile to the positions of two or more intersecting directions from the image data in the trabecular bone index computing region, and analyze the X-ray intensity profile to compute the trabecular bone index.

18. The program according to claim 17, wherein the program makes the computer perform analysis in the two or more intersecting directions, and compare each analysis result to each other to compute the trabecular bone index.

19. The program according to claim 16, wherein the program makes the computer obtain a trabecular image number at a time of analyzing the X-ray intensity profile.

20. The program according to claim 16, wherein the program makes the computer obtain the trabecular image interval at the time of analyzing the X-ray intensity profile.

21. The program according to claim 16, wherein the program makes the computer use frequency analysis at the time of analyzing the X-ray intensity profile.

22. The program according to claim 15, wherein
the bone-flesh boundary index computing region includes a bone portion in a neighborhood of the bone-flesh boundary in the subject, and
the program makes the computer analyze the X-ray intensity profile to the positions of the bone portion in the neighborhood of the bone-flesh boundary to compute the bone-flesh boundary index.

23. The program according to claim 15, wherein
the bone-flesh boundary index computing region includes the bone-flesh boundary in the subject to a degree of being capable of analyzing a shape, and
the program makes the computer acquire bone-flesh boundary shape data indicating the shape of the bone-flesh boundary from the image data in the bone-flesh boundary index computing region, and analyze the bone-flesh boundary shape data to compute the bone-flesh boundary index.

24. The program according to claim 23, wherein the program makes the computer use the frequency analysis at a time of analyzing the bone-flesh boundary shape data.

25. The program according to claim 15, wherein
the bone-flesh boundary index computing region includes the bone portion in the neighborhood of the bone-flesh boundary in the subject, and
the program makes the computer compute the bone-flesh boundary index based on information corresponding to a maximum X-ray intensity of the image data in the bone-flesh boundary index computing region.
